(19) United States
(12) Patent Application Publication
(10) Pub. No.: US 2006/0209064 A1
(43) Pub. Date: Sep. 21, 2006

(54) Image data generator and printer

(75) Inventor: Tsutomu Otani, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/338,055

(22) Filed: Jan. 23, 2006

(30) Foreign Application Priority Data
Jan. 21, 2005 (JP) 2005-013705

(51) Int. Cl. G06T 15/20; H04N 1/40; G06T 15/00; G06T 15/30; G06K 15/00; G06T 17/20

(52) U.S. Cl. 345/419; 345/423; 345/427; 358/3.24

(57) ABSTRACT

First image data representative of a first image of an object is generated based on first polygon data representative of a three-dimensional shape of the object with coordinates of apexes of each of first polygons constituting a surface of the object and having a first size. The first image is displayed on a display. When a print instruction for the first image is detected, at least one of the first image data and the first polygon data is acquired to generate second image data representative of a second image of the object, based on second polygon data representative of the three-dimensional shape of the object with coordinates of apexes of each of second polygons constituting the surface of the object and having a second size smaller than the first size, and the second image is displayed on the display. Print data is generated based on the second image data when a print authorization is acquired. A third image represented by the print data is printed.

### BACKGROUND OF THE INVENTION

The present invention relates to a technology of forming to print a two-dimensional image from a three-dimensional data formed by using a computer graphics technology.

In recent years, a virtual world created by imagination can be expressed as if the world were existed by progress of a so-to-speak computer graphics (CG) technology. Further, there has also been developed a game machine in which in a virtual world expressed as if it were existed by utilizing such a technology, a game is advanced by moving a character which is also expressed as if it were existed and the game machine is widely used currently.

In a case of dealing with a three-dimensional body on CG, it is general to use a method of dividing a surface of the body into small plane polygonal shapes and expressing the body by an aggregation of the polygonal shapes. The polygonal shape used for specifying a shape of the body in this way is referred to as “polygon”. Since the polygon is a plane, the surface of the body expressed by using the polygon gives an angular feeling and there is a concern of giving a strange feeling, however, such a problem can be improved to a nonproblematic degree in fact by reducing a size of the polygon. Naturally, when the size of the polygon is reduced, a number of the polygons serving as the body is increased and therefore, it is difficult to swiftly display an image. Hence, a size of polygon is determined by a balance between a request for expressing the body as if it were an existing object and a speed of expressing the image.

According to the game machine utilizing the CG technology, a request for the speed of expressing the image is further enhanced. That is, in a case where the game machine, a character needs to be moved fast in response to an operation of a game player and for such a purpose, the image needs to be displayed swiftly. On the other hand, the character is frequently moved during the game to bring about a characteristic that the angular feeling of the surface is difficult to be conspicuous. Hence, the size of the polygon is set by placing a weight on the speed of displaying the image rather than expressing the body as if it were real. Further, various technologies have been developed and proposed to be able to display an image swiftly while expressing a body expressed by a polygon as if it were a more real object (for example, disclosed in Japanese Patent Publication Nos. 7-262387A and 8-161510A)

However, even when an image is expressed as if the image were an existing object on a screen, when the image is printed on a medium capable of displaying the image further dearly as in, for example, a paper medium, there poses a problem that it is known that a surface of an object is angular. Further, when the image is printed on a paper medium or the like, an image clearer than that displayed on a screen is provided and therefore, there poses a problem that it is difficult to grasp a printed state on a screen and an obtained image quality is known unless the image is actually printed.

### SUMMARY OF THE INVENTION

It is therefore an object of the invention to provide a technology in which even when a body displayed on a screen is printed on a medium capable of further clearly displaying the object as in the paper medium or the like, the body can be expressed as if it were an existing object and a quality of a printed image can be grasped to some degree even on a screen.

In order to achieve the above object, according to the invention, there is provided an image data generator, comprising:

a first image data generator, operable to generate first image data representative of a first image of an object, based on first polygon data representative of a three-dimensional shape of the object with coordinates of apexes of each of first polygons constituting a surface of the object and having a first size;

a second image data generator, operable to acquire at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size;

a display, operable to display the first image and the second image; and

a print data generator, operable to cause the display to display the second image when a print instruction for the first image displayed on the display is detected, and operable to generate print data based on the second image data when a print authorization is acquired, the print data being representative of a third image to be printed by a printer.

According to the invention; there is also provided an image generating method, comprising:

generating first image data representative of a first image of an object, based on first polygon data representative of a three-dimensional shape of the object with coordinates of apexes of each of first polygons constituting a surface of the object and having a first size;

displaying the first image on a display;

detecting a print instruction for the first image;

acquiring at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size; and

displaying the second image on the display.

With the above configurations, since print data is generated from the smaller polygon data, in the image to be printed, the surface of the object is expressed as a smooth surface including a curved face portion. Therefore, in the printed image provided based on the print data, the surface of the object is not angular and the printed image can be provided as if an existing object were taken by a photograph.

Further, since the second image is once displayed on the display before the generation of the print data, a fine image formed with smaller polygons which is similar to an image to be printed can be confirmed on the display in advance. Therefore, an appearance of the image to be printed can be grasped before the actual printing operation.

It may be determined that the print authorization is acquired in a case where no instruction is detected while the second image is displayed on the display for a prescribed time period.

In this case, the print data generation can be surely executed.

The image data generator may further comprise a storage, storing the first polygon data and the second polygon data. The second image data generator may be operable to replace the first polygon data with the second polygon data to generate the second image data.

The second polygons may be formed by dividing at least one of the first polygons.

In this case, since the second polygon is formed at a position at which the first polygon is located, it is not necessary to align the second polygon with the first polygon. Accordingly, processing can be simplified.

The image data generator may further comprise:

an adjuster, operable to adjust at least one of a position and an attitude of the object in the second image; and

an image updater, operable to change the second polygon data in accordance with the adjustment performed with respect to the at least one of the position and the attitude of the object, in order to update the second image.

In this case, since the second image can be modified, a more preferable image can be printed.

The image data generator may further comprise an adjuster, operable to adjust a condition for capturing the first image displayed on the first display. The second image data generator may be operable to generate the second image data with reference to the adjusted condition. The image capturing condition may include an area to be printed, a focusing position in the second image, a focal length and an aperture value.

In this case, an impression as if an existing object were photographed can be given and therefore, the provided image can further be provided with a feeling of presence.

According to the invention, there is also provided a printer, comprising:

a first image data generator, operable to generate first image data representative of a first image of an object, based on first polygon data representative of a three-dimensional shape of the object with coordinates of apexes of each of first polygons constituting a surface of the object and having a first size;

a second image data generator, operable to acquire at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size;

a display, operable to display the first image and the second image; and

a print data generator, operable to cause the display to display the second image when a print instruction for the first image displayed on the display is detected, and operable to generate print data based on the second image data when a print authorization is acquired, the print data being representative of a third image to be printed by the printer.

According to the invention, there is also provided a printing method, comprising:
generating first image data representative of a first image of an object, based on first polygon data representative of a three-dimensional shape of the object with coordinates of apexes of each of first polygons constituting a surface of the object and having a first size;

displaying the first image on a display;

detecting a print instruction for the first image;

acquiring at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size;

displaying the second image on the display;

generating print data based on the second image data when a print authorization is acquired; and

printing a third image represented by the print data.

According to the invention, there is also provided a program product comprising a program adapted to cause a computer to execute an image generating method, comprising:

generating first image data representative of a first image of an object, based on first polygon data representative of a three-dimensional shape of the object with coordinates of apexes of each of first polygons constituting a surface of the object and having a first size;

displaying the first image on a display;

detecting a print instruction for the first image;

acquiring at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size; and

displaying the second image on the display.

According to the invention, there is also provided a program product comprising a program adapted to cause a computer to execute a printing method, comprising:

generating first image data representative of a first image of an object, based on first polygon data representative of a three-dimensional shape of the object with coordinates of apexes of each of first polygons constituting a surface of the object and having a first size;

displaying the first image on a display;

detecting a print instruction for the first image;

acquiring at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size;

displaying the second image on the display;

generating print data based on the second image data when a print authorization is acquired; and

printing a third image represented by the print data.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing an image data generator and a color printer according to a first embodiment of the invention;

FIG. 2 is a schematic view showing a configuration of the color printer;

FIG. 3 is a schematic view showing an arrangement of nozzles in an ink ejecting head in the color printer;

FIG. 4 is a schematic view showing a state that a screen in a game is displayed on a monitor;

FIG. 5 is a schematic view showing an area that a two-dimensional image is directly displayed in the game screen of FIG. 4;

FIGS. 6A and 6B are perspective views showing a shape of a flying boat serving as a main character in the game;

FIG. 7 is a schematic view showing a state that the shape of the flying boat is expressed by minute planar polygons.

FIG. 8 is a schematic view showing an object table for managing polygon data of respective objects in the game;

FIG. 9 is a schematic view showing data structure of the polygon data;

FIG. 10 is a flowchart of processing for displaying the game screen on the monitor;

FIG. 11 is a diagram showing a principle of rendering in FIG. 10;

FIGS. 12A and 12B show equations for projecting apex coordinates of polygons constituting the object onto coordinates on a two-dimensional plane;

FIG. 13 is a diagram showing a projected image generated by the rendering;

FIG. 14 is a table showing data structure of drawing command output to draw an image generated by the rendering;

FIG. 15 is a flowchart of processing for printing image;

FIG. 16 is a schematic view showing a state that the shape of the flying boat is expressed by the minute polygons;

FIG. 17 is a table referred to determine whether the polygon data exists or not;

FIG. 18 is a flowchart of processing for confirming an image to be printed;

FIG. 19 is a schematic view showing a state that a screen for determining image capturing conditions is displayed on the monitor;

FIG. 20 is a schematic view showing a state that a screen for confirming the image to be printed is displayed on the monitor;

FIG. 21 is a schematic view showing a state that a screen for determining print conditions is displayed on the monitor;

FIG. 22 is a flowchart of processing for outputting print data;

FIG. 23 is a diagram showing a lookup table referred to execute color conversion shown in FIG. 22;

FIG. 24 is a diagram showing a part of a dither matrix used in the dithering method to execute halftoning shown in FIG. 22;

FIG. 25 is a diagram showing determination as to whether a dot is formed or not with reference to the dither matrix;

FIG. 26 is a flowchart of processing for printing an image which is performed in an image data generator and a printer according to a second embodiment of the invention;

FIG. 27 is a diagram showing an example in which minute polygons are generated from normal polygons; and

FIGS. 28A and 28B are diagrams showing another examples in which the minute polygons are generated from the normal polygons.

### DETAILED DESCRIPTION OF THE EMBODIMENTS

Embodiments of the invention will be described below in detail with reference to the accompanying drawings.

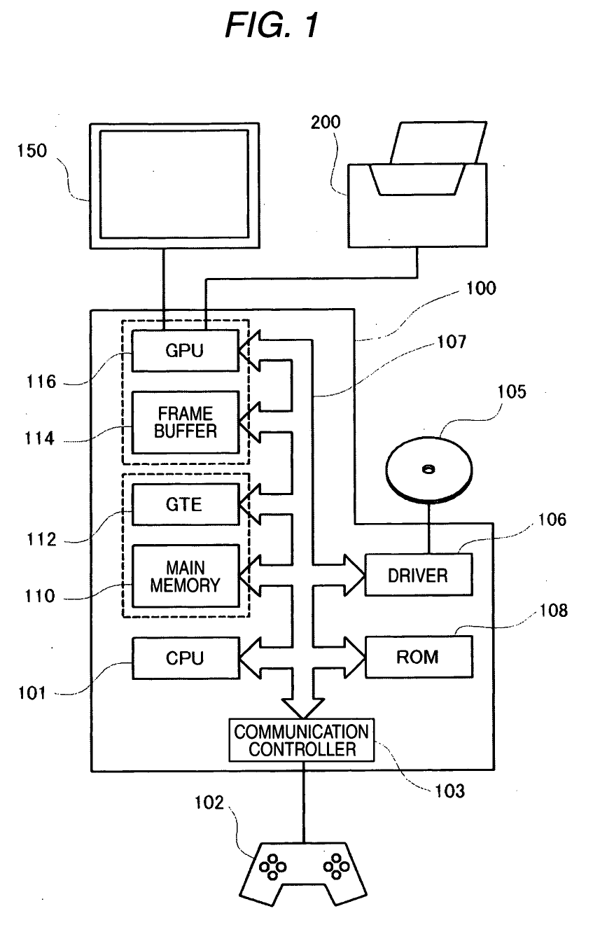

As shown in FIG. 1, a game machine 100 according to a first embodiment is constituted by connecting a main memory 110, a coordinates transformer (hereinafter, the GTE: Geometry Transfer Engine) 112, a frame buffer 114, an image processor (hereinafter, the GPU: Graphic Processing Unit) 116, a the ROM 108, a driver 106, a communication controller 103 and the like to be able to exchange data from each other by way of a bus centering on the CPU 101. Further, the game machine 100 is connected with a controller 102 or the like for operating the game machine 100. Further, the game machine 100 is also connected with a color printer 200 to be able to output a screen in the midst of a game by the color printer 200.

The CPU 101 is a central processing unit for executing so-to-speak arithmetic operation or logical operation, which governs to control a total of the game machine 100. The ROM 108 is a memory exclusive for reading and stored with various programs including a program (boot program) initially executed by the CPU 101 after activating the game machine 100. The main memory 110 is a memory capable of reading and writing data and is used as a temporarily storing region when the CPU 101 executes arithmetic operation or logical operation. The GTE 112 executes operation for moving and rotating a geometrical shape in a three-dimensional space at high speed while making access to the main memory 110 under control of the CPU 101. The GPU 116 executes a processing for forming a screen displayed on a monitor 150 at a high speed by receiving an instruction from the CPU 101. The frame buffer 114 is an exclusive memory used for forming the screen displayed on the monitor 150 by the GPU 116. The GPU 116 displays a screen in the midst of a game by reading data on the screen formed on the frame buffer 114 to output to the monitor 150. Further, when the screen in the midst of a game is printed, the screen in the midst of the game is printed by supplying data formed on the frame buffer 114 to the color printer 200 by way of the GPU 116.

Programs and various data for executing a game are stored in a storage disk of so-to-speak compact disk or digital video disk. When the storage disk 105 is set to the game machine 100, programs and data stored to the storage disk 105 are read by the driver 106 and temporarily stored in the main memory 110. Further, when a content of operating the controller 102 is inputted to the CPU 101 by way of the communication controller 103, the CPU 101 reads programs stored in the main memory 110 and executes predetermined processings, thereby, a game is executed.

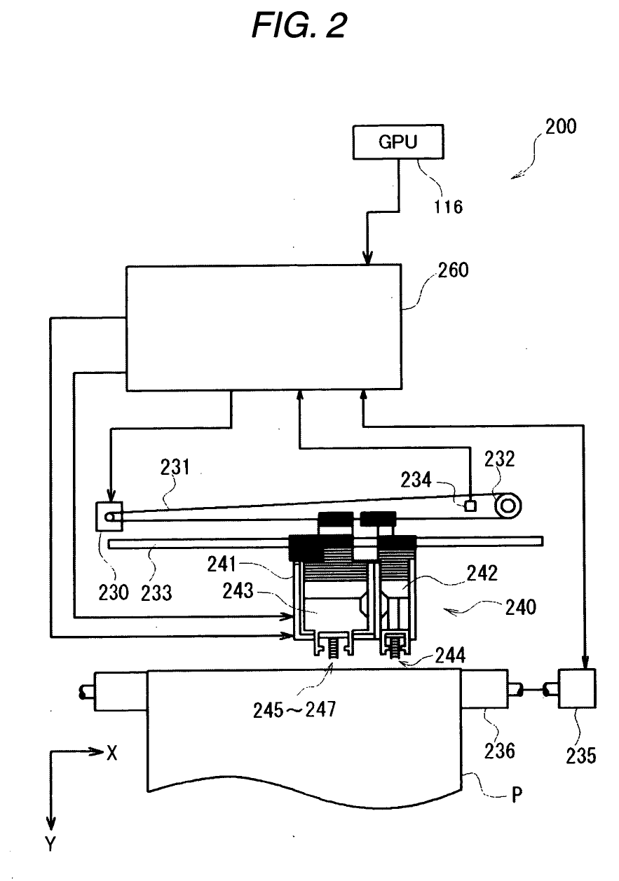

As shown in FIG. 2, the color printer 200 is an ink jet printer capable of forming dots of 4 color inks of cyan, magenta, yellow, black. Naturally, an ink jet printer capable of forming ink dots of a total of 6 colors including a cyan ink having a low concentration of a die or a pigment (light cyan) and a magenta ink having a low concentration of a die or a pigment (light magenta) in addition to the inks of 4 colors can also be used. Further, in the following, depending on cases, cyan, ink, magenta ink, yellow ink, black ink, light cyan ink, light magenta ink may be abbreviated as C ink, M ink, Y ink, K ink, LC ink, LM, ink, respectively.

As illustrated, the color printer 200 is constituted by a mechanism of ejecting inks and forming dots by driving a printing head 241 mounted on a carriage 240, a mechanism of reciprocating the carriage 240 in an axial direction of a platen 236, by a carriage motor 230, a mechanism for carrying print sheet P by a sheet feeding motor 235, and a control circuit 260 for controlling to form dots, move the carriage 240 and carry the print sheet.

The carriage 240 is mounted with an ink cartridge 242 for containing K ink and an ink cartridge 243 containing various inks of C ink, M ink, Y ink. When the ink cartridges 242, 243 are mounted to the carriage 240, respective inks in the cartridges are supplied to ink ejecting heads 244 through 247 of respective colors provided at a lower face of the printing head 241 through introducing tubes, not illustrated.

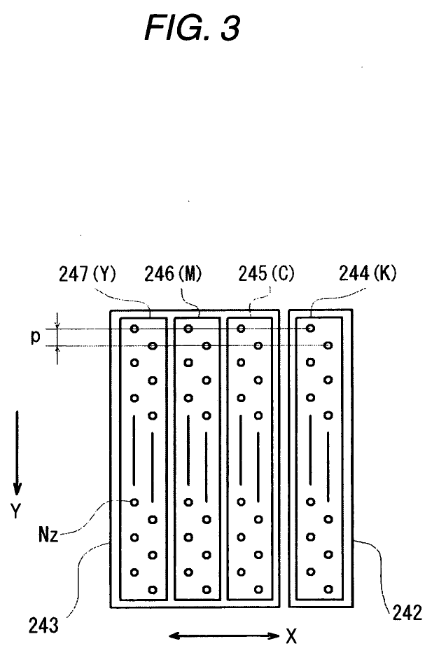

As shown in FIG. 3, bottom faces of the ink ejecting heads are formed with 4 sets of nozzle arrays for ejecting inks of respective colors of C, M, Y, K and the nozzles Nz of 48 pieces per set of a nozzle array are aligned at a constant pitch k.

The control circuit 260 is constituted by connecting the CPU, the ROM, RAM, PIF (peripheral apparatus interface) and the like to each other by a bus. The control circuit 260 controls primary scanning operation and secondary scanning operation of the carriage 240 by controlling operation of the carriage motor 230 and the sheet feeding motor 235 and controls to eject ink drops from the respective nozzles at pertinent timings based on print data supplied from outside. In this way, the color printer 200 can print a color image by forming respective colors of ink dots at pertinent positions on the print medium under control of the control circuit 260.

Further, when drive signal waveforms supplied to the nozzles are controlled for ejecting ink drops, ink dots having different sizes can also be formed by changing the sizes of ink drops to be ejected. When the sizes of the ink dots can be, controlled in this way, by properly using ink dots having different sizes in accordance with a region of an image to be printed, an image having a higher image quality can also be printed.

Further, various methods are applicable to a method of ejecting ink drops from ink ejecting heads of respective colors. That is, a type of ejecting ink by using a piezoelectric element, a method of ejecting ink drops by producing bubbles in an ink path by a heater arranged at the ink path and the like can be used. Further, there can also be used a printer of a type of forming ink dots on print sheet by utilizing a phenomenon of thermal transcription or the like, or a type of adhering respective colors of toner powders on a print medium by utilizing static electricity instead of ejecting inks.

According to the color printer 200 having the above-described hardware constitution, by driving the carriage motor 230, respective colors of the ink ejecting heads 244 through 247 are moved in a primary scanning direction relative to the print sheet P and by driving the sheet feeding motor 235, the print sheet P is moved in a secondary scanning direction. By ejecting ink drops by driving the nozzles at pertinent timings in synchronism with movements of primary scanning and secondary scanning of the carriage 240 by the control circuit 260, the color printer 200 can print a color image on the print sheet.

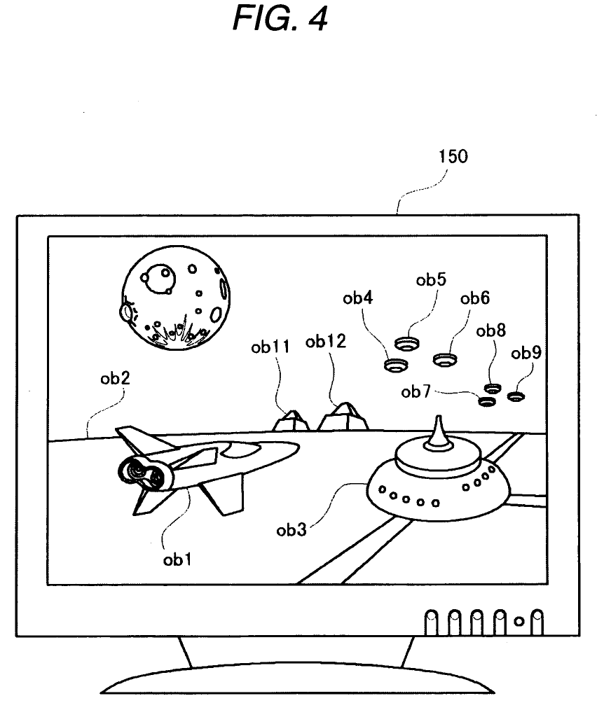

In this embodiment, a game is proceeded by operating a main character in a virtual three-dimensional space set as the stage of the game. As shown in FIG. 4, an imaginary planet surface is displayed on the illustrated screen and a behavior of setting various buildings is virtually displayed at the surface of the planet. The game is executed by maneuvering and advancing a flying boat serving as a main character in the stage of the game.

Although only a two-dimensional shape can be expressed on the screen of the monitor 160, at inside of the game machine 100, the planet surface, the flying boat, the various kinds of buildings and the like are expressed as bodies having three-dimensional shapes. An object dealt with as having a three-dimensional shape at inside of the game machine 100 in this way is referred to as “object” in the specification. In the screen exemplified in FIG. 4, a flying boat ob1 displayed to be large substantially at a center of the screen, a planet surface ob2, a dome-shaped building ob3, two pyramid-shaped buildings ob11, ob12 seen remotely, further, six of flying circular disks ob4 through ob9 flying above the planet surface and the like are objects and data of three-dimensionally expressing surface shapes of bodies are stored therefor.

Therefore, when by operating the flying boat ob1 serving as the main character, relative to the flying boat ob1, positional relationships of other objects (for example, buildings, flying circular disks and the like) are changed, in accordance therewith, ways of viewing the objects on the monitor 150 are also changed. As a result, although the objects of the flying boat ob1, the planet surface ob2 and the like are created by imagination, the objects can be displayed on the monitor 150 as if the objects were really present. Further, according to the game machine 100 of the embodiment, by printing the screen displayed on the monitor 150, the image as if the image were taken by a photograph can be printed although a description will be given later in details.

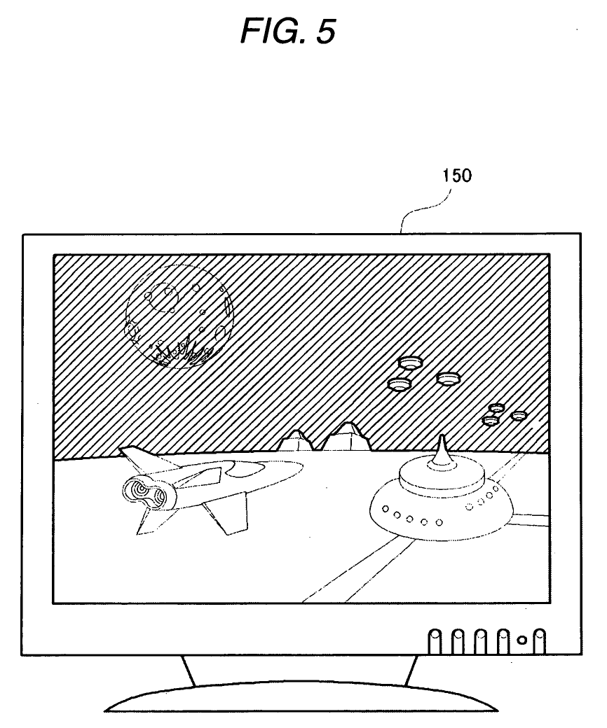

Further, according to the example shown in FIG. 4, a portion of the sky of the planet add the satellites floating in the sky do not constitute objects but two-dimensional images displayed on the monitor 150 as they are. Therefore, with regard thereto, even when the flying boat ob1 is operated, ways of viewing these on the monitor 150 are not changed. This is because these are extremely remote in comparison with a range of moving the flying boat ob1 and therefore, even when a position of the flying boat ob1 is changed, ways of viewing these hardly change and therefore, it is sufficient when these are dealt with as two-dimensional images. In FIG. 5, a hatched region displays two-dimensional images on the screen of the monitor 150 as they are. In this embodiment, two-dimensional images can be fitted to a portion of a screen displayed on the monitor 150.

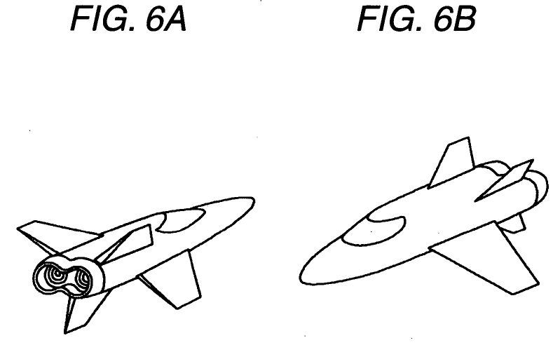

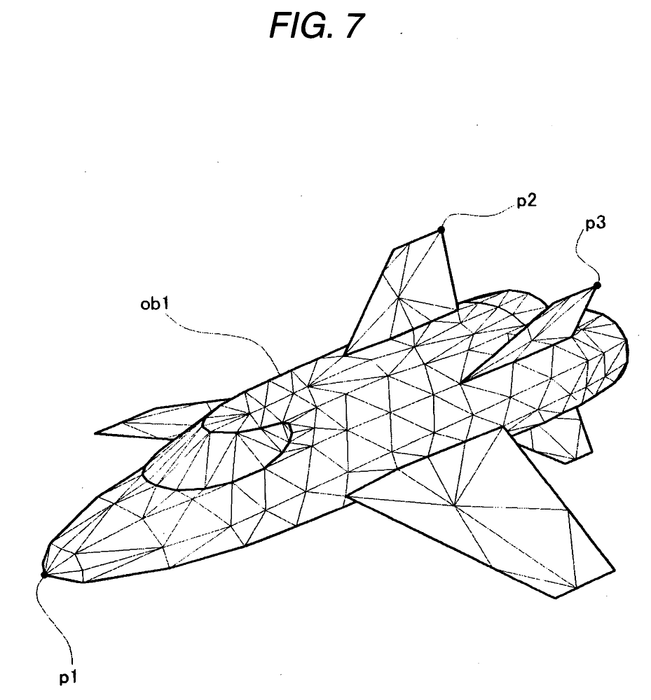

Next, an explanation will be given of a method of dealing with a body as an object having a three-dimensional shape by the game machine 100. As shown in FIGS. 6A and 6B, almost all portions of a surface of the flying boat ob1 are constituted by smooth curved faces. In the game machine 100, the object having the three-dimensional curved faces is expressed by using a plane polygonal shape. That is, the three-dimensional curved face is divided into small plane polygonal shapes and approximately expressed by the plane polygonal shapes as shown in FIG. 7.

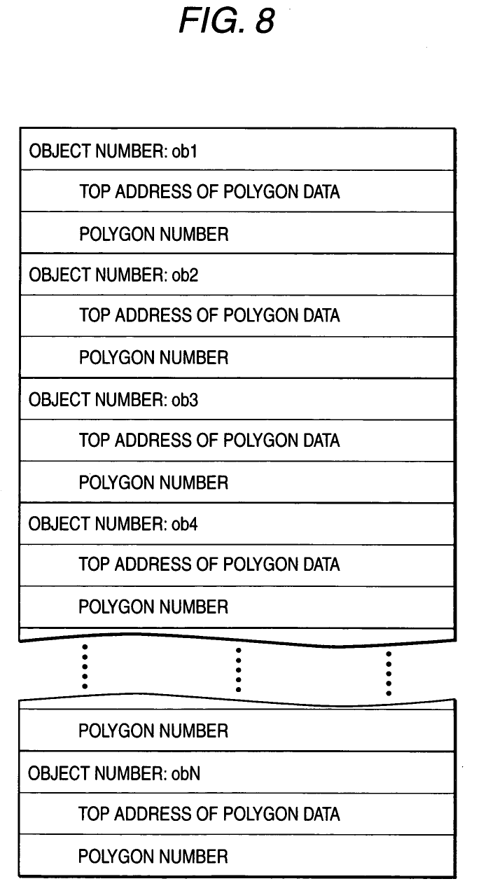

The plane polygonal shape may be referred to as “polygon”. In this embodiment, all of objects are expressed as aggregations of polygons and the shape of the object is expressed by three-dimensional coordinate values of respective apexes constituting the polygon. In the specification, data expressing the shape of the object, by coordinates of the apexes of the polygons is referred to as “polygon data”. Further, the polygon data of the respective objects are controlled by a table referred to as object table shown in FIG. 8.

The object table is stored with object numbers for identifying respective objects, top addresses of the main memory 110 stored with polygon data showing shapes of objects and polygon numbers constituting the objects. In the object table, the object number and a record set including the top address of the polygon data and the polygon number are set for every object.

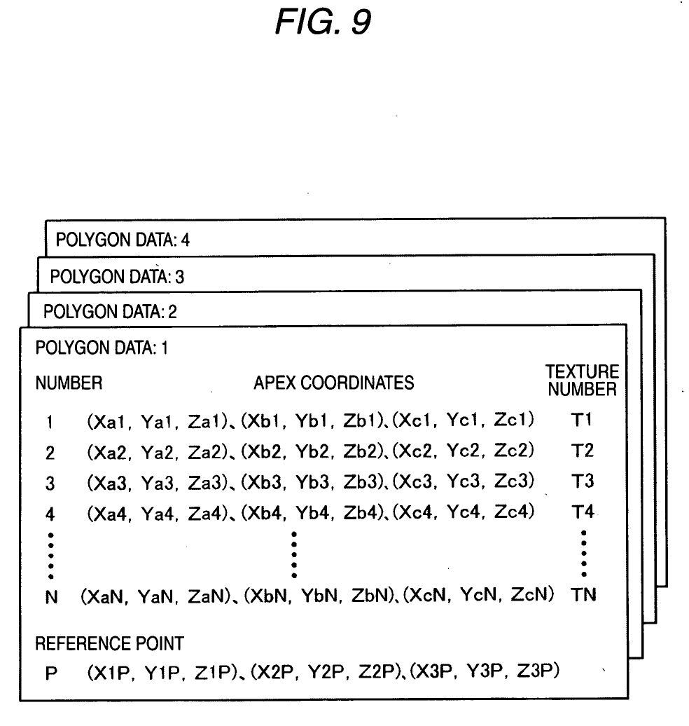

As shown in FIG. 9, the polygon data are constituted by serial numbers of polygons, XYZ coordinate values of apexes constituting the respective polygons, numbers of textures attached to the polygons, XYZ coordinate values of reference points set to the objects. Among them, single sets of the numbers of the polygons, the apex coordinates, the texture numbers are set for the respective polygons, on the other hand, the XYZ coordinate values of the reference points are set with regard to the objects.

Numbers of the apex coordinates set to the respective polygons are set with numbers in accordance with shapes of the polygons. For example, when the polygon is constituted by a triangular shape, the polygon is constituted by three apexes and therefore, the polygon is set with three apex coordinates. Similarly, when the polygon is constituted by a quadrangular shape, four of apex coordinates are set. According to the embodiment, all of the objects are constituted by triangular polygons and therefore, each polygon is set with three apex coordinates.

Further, the texture number can be regarded as a number indicating a color to be painted at inside of the polygon. For example, when a surface of an object is red, all the polygons constituting the object may be painted with red color. In that case, the texture number of the polygon is designated with a number indicating red color. However, not only the colors but also surfaces having various metallic lusters of aluminum, brass and the like, a transparent surface of glass or the like, a surface of wood skin or the like can also be designated as texture numbers. The texture number is a number designating a state of a surface provided to the polygon in this way.

On the other hand, the reference point set to the object is XYZ coordinate values used for expressing a position and an attitude of the object in the three-dimensional space. In this embodiment, a screen of the monitor 150 displayed in the midst of the game can be printed as a clear image as if the image were a photograph and although a description will be given later in details, by using information of the position and the direction of the object constituting the object, such a clear image can be printed. Therefore, the object is set with the reference point in order to specify a position in the three-dimensional space at which the object is present and a direction in which object is directed.

With regard to the flying boat (object number ob1) shown in FIG. 7, there are provided a total of three reference points of a reference point P1 provided at an airframe front portion and reference points P2, P3 respectively provided at rear ends of left and right stabilizers. When a minimum of three reference points are provided in this way, the position and the direction of the object in the three-dimensional space can be specified. Naturally, the number of the reference points is not limited to three but a larger number of reference points may be provided. The polygon data shown in FIG. 9 are set with XYZ coordinate values of the reference points. Further, it is not necessarily needed to provide the reference points to all of the objects. With regard to the point, an explanation will be given later in details.

As has been explained above, according to the game machine 100 of the embodiment, all the objects are assigned with the object numbers and surface shapes of the objects are expressed by polygon data indicating the apex coordinates of the polygons. Further, when by citing the object table from the object number, the top address of the corresponding polygon data is acquired, the apex coordinates expressing the three-dimensional space of the object can be acquired by reading data written at and after the address. Image data for displaying on the monitor 150 of the game machine 100 is formed by subjecting the polygon data indicating the three-dimensional shape acquired in this way to a processing, mentioned later.

Further, although according to the object table exemplified in FIG. 8, only two items of the top address of the polygon data and the polygon number constituting the object are set in correspondence with the object number, other items may be set. For example, data indicating a type of the polygon constituting the object, that is, by what angles of a polygon shape a polygon is constituted, whether the reference point is, provided to the polygon, data indicating a number of the reference points can be set in correspondence with the object number.

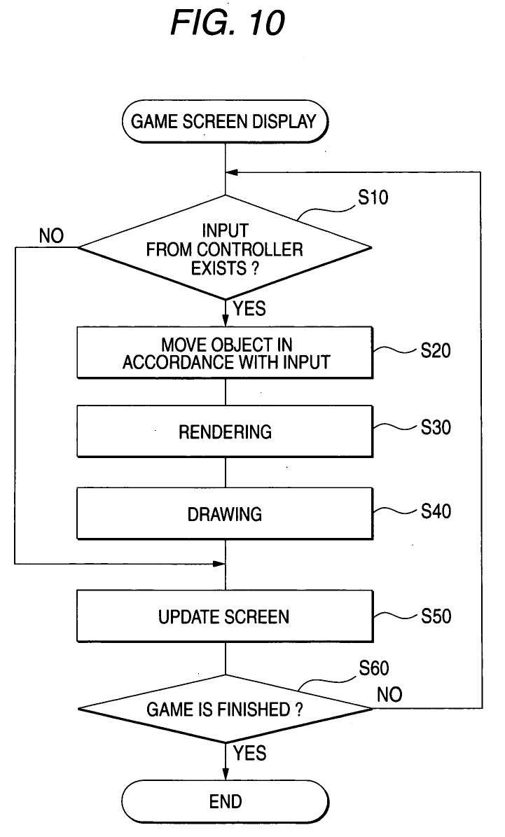

Next, processings executed in corporation with the main memory 110, the GTE 112, the frame buffer 114, the GPU 116 and the like centering on CPU 101 will be described with reference to the flowchart shown in FIG. 10.

When the game screen displaying processing is started, the CPU 101 determines whether there is an input from the controller 102 (step S10). As described above, in the midst of the game, the operation to the game machine 100 is executed exclusively by the controller 102 and therefore, first, it is determined whether there is the operation input from the controller 102. Further, when there is not the input (step S10: No), a processing of updating the display of the screen by outputting the image data stored to the frame buffer 114 to the monitor 150 (screen updating processing) is executed (step S50). The image date to be displayed on the monitor 150 is formed and stored in the frame buffer 114. Contents of a processing for forming the image data to store to the fine buffer 114 and the screen updating processing of outputting the image data stored to the frame buffer 114 to the monitor 150 will be described later. On the other hand, when it is determined that there is the input from the controller 102 (step S10: yes), a series of processings, mentioned later, are executed in order to reflect the content of the operation by the controller 102 on the screen of the monitor 150.

When the input from the controller 102 is detected, a processing of moving the object operated by the controller 102 in the three-dimensional space set as the stage of the game by a distance and in a direction in accordance with the operation is executed (step S20). As an example, an explanation will be given of a case in which the operation by the controller 102 is for advancing the flying boat ob1. As described above, the flying boat ob1 is expressed by the plurality of polygons at inside of the game machine 100 (refer to FIG. 7) and the apex coordinates of the respective polygons are set to the polygon data (refer to FIG. 9). Further, the top address of the memory region stored to the polygon data can be acquired by referring to the object table.

Hence, when the flying boat ob1 is advanced, first, in reference to the object table, the top address of the polygon data in correspondence with the flying boat (object number ob1) is acquired. Next, the apex coordinates constituting the respective polygons are acquired by reading the polygon data stored to the memory region constituting the front acquired address on the main memory 110. The apex coordinates acquired in this way constitute coordinates expressing a position of the flying boat ob1 at a current time point in the three-dimensional space as the stage of the game.

With regard to the point, a more or less supplementary explanation will be given. The storing disk 105 is stored with initial values of the polygon data with regard to the respective objects. Starting the game the initial values of the polygon data are read from the storing disk 105 and stored to the memory 110 and the top address values storing the polygon data are set to the object table. Further, when the object is moved rotated or deformed in accordance with proceeding the game, the content of the polygon data stored to the main memory 110 is updated by a processing, mentioned later. Therefore, when the top address is acquired by referring to the object table, the apex coordinates at the current time point of the respective objects can be read.

Here, the controller 102 is operated to advance the flying boat ob1 and therefore, at S20 of the game screen displaying processing shown in FIG. 10, by referring to the object table, the polygon data indicating the current position of the flying boat ob1 is acquired from the main memory 110. Successively, a direction and a moving amount of moving the flying boat ob1 in the three-dimensional space are determined by an amount of operating the controller 102 and the coordinate values of the flying boat ob1 after movement are calculated. The operation is executed at high speed by the GTE 112 under control of the CPU 101. Specifically, when the moving direction and the moving amount of the flying boat ob1 are determined, the CPU 101 supplies the moving direction of the moving amount to the GTE 112 along with the value of the top address of the polygon data. The GTE 112 calculates the apex coordinates after movement by executing coordinates transformation for the apex coordinates of the polygon data after reading the polygon data of the flying boat ob1 based on the supplied top address. The polygon data of the main memory 110 is updated by the apex coordinates after transformation acquired in this way. Although in the above-described, an explanation has been given of the case of advancing the flying boat ob1, when other object is operated by the controller 102, a similar processing is executed for the operated object. As a result, the polygon data of the respective objects stored to the main memory 110 are always stored with the newest coordinate values of the objects.

When the operation of the controller 102 is reflected to the object position in this way, a processing (rendering processing) of forming the data of the two-dimensional image from the polygon data of the respective objects is started (step S30). In the rendering processing, by executing a processing of projecting the three-dimensional objects expressed by the polygon data on a plane in correspondence with the screen of the monitor 150, the two-dimensional image is formed from the three-dimensional objects.

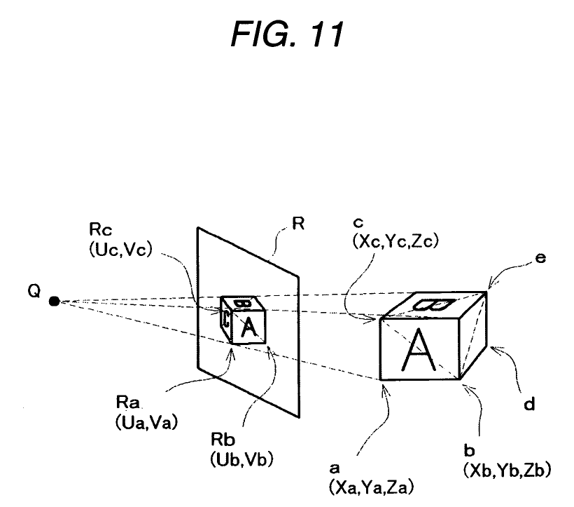

FIG. 11 shows a behavior of forming a two-dimensional image by subjecting an object in a shape of a dice to the rendering processing. In the rendering processing, first, an observing point Q for observing the object is set, successively, a projecting face R in correspondence with the screen of the monitor 150 is set between the object and the observing point Q. Further, an arbitrary point selected from a surface of the object and the observing point Q are connected by a straight line to determine an intersection at which the straight line intersects with the projecting face R. For example, when point “a” on the object is selected, a point Ra can be determined as an intersection at which a straight line connecting point “a” and the observing point Q intersects with the projecting face R. Here, as is well known, light is provided with a property of advancing straight and therefore, light coming out from point “a” and going to the observing point Q produces an image at point Ra on the projecting face R. In other words, point Ra on the projecting face R can be regarded as a point to which point “a” on the object is projected. Therefore, when such an operation is executed for all of the points on the surface of the object, the two-dimensional image of the object projected onto the projecting face Ra can be acquired.

Incidentally, as described above, the object is expressed by the polygons and therefore, it is not necessary to execute such an operation with regard to all the points on the surface of the object but may be executed only with regard to the apex coordinates of the polygons. For example, assume that point b and point c on the surface of the object are respectively projected to point Rb, point Rc on the projecting face R. In this case, the polygon in a triangular shape constituting apexes by point a, points b, point c on the object may be regarded to be projected to a region in a triangular shape constituting the apexes by point Ra, point Rb, point Rc on the projecting face R. Further, when the polygon on the object is constituted by, for example, red color, also a region in a triangular shape constituted by projecting the polygon onto the projecting face R may be regarded to be constituted by red color. That is, the texture number provided to the polygon on the object can be regarded to be succeeded also to a region projected on the projecting face R.

Further, in the rendering processing, also a processing referred to as so-to-speak shadow face erasing is executed. The shadow face erasing is a processing of erasing a portion of the surface of the object constituting a shade of other surface. For example, in the example shown in FIG. 11, a polygon constituting apexes by point b, point d, point e of the surface of the object is disposed on a back side of the object in view from the observing point Q, a total thereof constitutes a shade of other surface and therefore, an image thereof is not produced on the projecting face R. Hence, with regard to the polygon, a projected image thereof is made not to be displayed on the projecting face R. Further, depending on the shape of the object and setting the observing point Q, there is also a case in which only a region of a portion of a certain polygon constitutes a shade of other surface. In such a case, a display of only a portion of the polygon constituting the shade is omitted and the projected image is displayed only for a portion which does not constitute a shade.

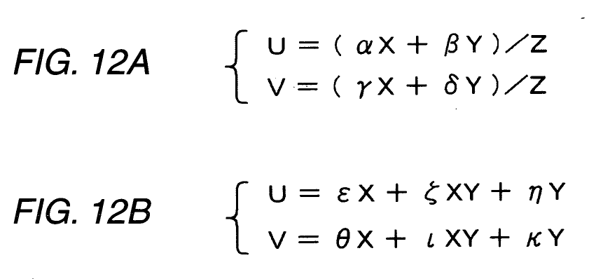

In this way, in the rendering processing, a processing of calculating coordinate values when the apexes of the polygons constituting the object are projected onto the projecting face R. Such coordinate values can comparatively simply be calculated. FIG. 12A shows a calculation equation for calculating coordinate values (U, V) on the projecting face R provided by projecting coordinate points (X, Y, Z) on the object. Here, α, β, γ, δ are coefficients determined by a distance from the observing point Q to the projecting face R, or to the object. Or, simply, a calculation equation which does not include a division can also be used as shown by FIG. 12B. Here, ε, ζ, η, θ, ι, κ are coefficients respectively determined by a distance from the observing point Q to the projecting face R, or to the object.

Further, although a detailed explanation will be omitted, in the rendering processing, there may be carried out a processing referred to as shading for shading the surface of the object by placing a light source at a previously set position in the three-dimensional space, or a processing or reducing a brightness at a remotely disposed portion or gradating a projected image in order to emphasize a depth perception. The rendering processing comprising such a series of processings is executed by receiving an instruction from the CPU 101 by the GTE 112, executing predetermined operation to the polygon data stored to the main memory 110 and updating the polygon data on the memory by using a provided result. Further, when the above-described processings are executed for all the objects appearing on the screen of the monitor 150, the rendering processing indicated at step S30 of FIG. 10 is finished.

Successive to the above-described rendering processing, the CPU 101 of the game machine 100 starts a drawing processing (step S40 of FIG. 10). The drawing processing is a processing of forming the image data set with gray scale values for respective pixels from the projected image formed by the rendering processing. That is, the projected image provided by the rendering processing is expressed by a style using coordinates of apexes of polygonal shapes projected with polygons and texture numbers to be provided to the polygonal shapes. On the other hand, the image data which can be displayed on the monitor 150 is expressed by a style finely dividing the image into small regions referred to as pixels and set with gray scale data (normally, data expressing brightness) for the respective pixels. When one kind of brightness data is set to each pixel, the image data becomes the image data of a monochromatic image and when brightness data of respective colors of ROB constituting three primary colors of light is set, the image data becomes an image data of a color image. Further, in place of the brightness data of respective colors of RGB, a color image can also be expressed by using two kinds of gray scale data in correspondence with brightness of color and gray scale data in correspondence with chrominance. At any rate, data expressing the projected image provided by the rendering processing cannot be displayed on the monitor 150 as it is and therefore, a processing of converting the data into a data style which can be displayed on the monitor 150 is executed. Such a processing is a processing referred to as drawing processing. Further, as described by using FIG. 5, when two-dimensional image is fitted to the screen, data of the two-dimensional image may be fitted thereto in the drawing processing.

When the drawing processing is started, the CPU 101 of the game machine 100 outputs a drawing instruction to the GPU 116. The drawing processing is executed by forming the image data to store to the frame buffer 114 by the GPU 116 by receiving the drawing instruction.

As described above, the projected image constituting the object of drawing is the two-dimensional image provided by projecting polygons constituting the object onto the projecting face R. In this embodiment, the object is constituted by using polygons all of which are formed by the triangular shape and therefore, as a rule, all the polygons are projected onto the projecting face R as an image of the triangular shape.

Further, polygon indicates a plane polygonal shape constituting the object as described above, strictly speaking, the polygonal shape constituted by projecting the polygon to the projecting face R differs from the polygon. However, in the following, for convenience of explanation, also the projected image of the polygon is referred to as polygon. Further, in differentiating these, the polygons may be referred to as “polygon constituting object” and “polygon constituting projected image”.

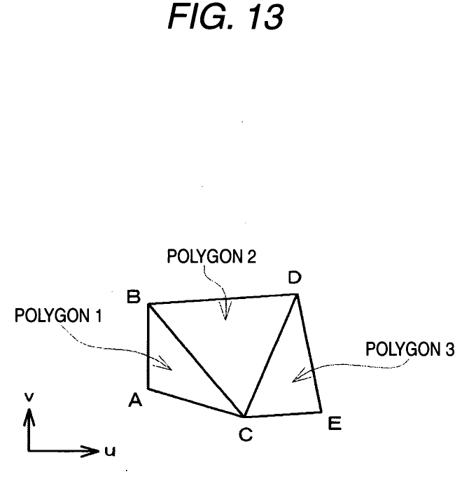

The projected image shown in FIG. 13 is constituted by three polygons of polygons 1, polygon 2, polygon 3. Further, all of projected images are constituted by triangular polygons to correspond to that all polygons constituting the object are constituted by triangular polygons and when the triangular polygons are projected to the projecting face R, triangular projected images are provided. Further, as described above in reference to FIG. 11, polygons constituting the projected images are attached with texture numbers the same as those of polygons constituting the object.

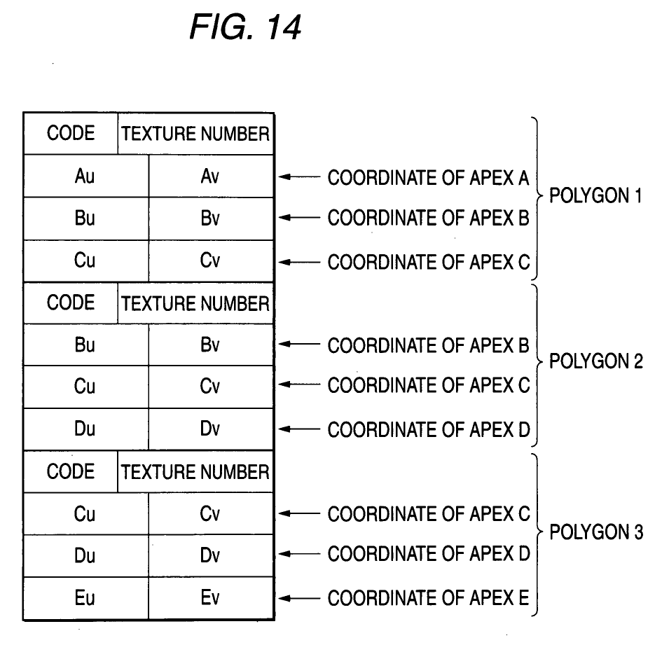

When the projected image is drawn, the CPU 101 outputs the drawing instruction having a data structure shown in FIG. 14. As illustrated, the drawing instruction is constituted by data sets each of which includes “CODE”, texture numbers, coordinate values of apexes on the projected face R for each of polygons. Here, “CODE” expresses that the instruction is the drawing instruction and becomes data for indicating a shape of the polygon constituting the object of drawing. That is, there is also a case in which the polygon constituting the object is not limited to the triangular shape but a polygon of a quadrangular shape or a pentagonal shape or the like is used, in accordance therewith, a shape of the polygon constituting the projected image is also changed. Further, even when the polygon of the object is constituted by the triangular shape, in a case where a portion thereof constitutes a shade of other polygon, the polygon on the projected race R can also be dealt with as a polygon of, for example, a quadrangular shape. In consideration thereof, according to the drawing instruction of the embodiment, a shape of the polygon is made to be able to be designated for each polygon.

The drawing instruction of the embodiment is set with the texture number successive to “CODE”. The texture number is a texture number attached to a polygon constituting the projected image and in almost all the cases, the texture number the same as the texture number attached to the polygon constituting the object. Further, in place of the texture number, color information (for example, gray scale values of respective colors of R, G, B) to be attached to the polygon can also be set.

Successive to the texture number, coordinate values on the projected face R of apexes constituting the polygons are set. A number of apex coordinates is determined by “CODE”, mentioned above. For example, when the shape of the polygon is designated as the triangular shape in “CODE”, three apex coordinates are set and when designated to a polygon of a quadrangular shape, four apex coordinates are set. The drawing instruction is constituted by a data structure in which data constituting single sets of “CODE”, the texture numbers, the apex coordinates are set for respective polygons constituting the projected image.

According to the drawing instruction exemplified in FIG. 14, three sets of data comprising “CODE”, the texture numbers and the apex coordinates are set in correspondence with that the projected image constituting the object of drawing is constituted by three polygons of polygon 1 through polygon 3. That is, with regard to polygon 1, successive to “CODE” and the texture number, coordinate values of three apexes A, B, C constituting polygon 1 are set. Further, with regard to polygon 2, successive to “CODE” and the texture number, coordinate values of three apexes B, C, D constituting polygon 2 are set, with regard to polygon 3, successive to “CODE”, the texture number, coordinate values of three apexes C, D, E constituting polygon 3 are set. The apex coordinates and the texture numbers of the polygons are stored to the main memory 110 after having being generated by the GTE 112 in the above-described rendering processing. The CPU 101 generates the drawing instruction having the data structure shown in FIG. 14 to supply to the GPU 116 by reading the data with regard to all the objects to be displayed on the screen of the monitor 150 from the data stored in the main memory 110.

When the GPU 116 receives the drawing instruction, the GPU 116 converts insides of the polygonal shapes constituted by connecting the respective apexes to the two-dimensional image printed by the color or the pattern indicated by the texture number. Further, the provided two-dimensional image is converted into data of an expressing style setting the gray scale data for the respective pixels constituting the image to store to the frame buffer 114 as the image data. As a result, the projected image expressed by the apex coordinates of the polygons on the projected face R and the texture numbers of the polygons is converted into the image data in a data style which can be expressed on the monitor 150 to be stored to the frame buffer 114. Further, the image data set with the gray scale values of respective colors of R, G, B at the respective pixels is formed. When the above-described processing is executed for all the projected images appearing on the screen of the monitor 150, the drawing processing shown in step S40 of FIG. 10 is finished.

When the drawing processing has been finished, at this occasion, a processing of updating the screen of the monitor 150 by outputting the image data provided on the frame buffer 114 to the monitor 150 is executed (step S50). That is, in accordance with the specification of the monitor 150 such as a screen resolution or a scanning system of interlace or noninterlace or the like, the image data is read from the frame buffer 114 to supply to the monitor 150 as a video signal. Thereby, the two dimensional image developed to the frame buffer 114 can be displayed on the screen of the monitor 150.

Further, when the displaying of the monitor 150 is updated by a frequency of at least 24 times or more per second, by the after image phenomenon provided to the retina of the human being, the image as if it were continuously moved can be displayed. In this embodiment, by updating the display of the screen by executing the game screen displaying processing shown in FIG. 10 at a frequency of about 30 times per second, the display can be executed as if the various objects of the flying boat ob1 and the like is continuously moved in the screen of the monitor 150. Further, in order to be able to execute such a high speed processing, the game machine 100 of the embodiment is mounted with the GTE 112 capable of executing various operations including coordinates transformation at high speed, the main memory 110 capable of reading and writing a large amount of data used in the operations at high speed, the GPU 116 swiftly generating image data based on the drawing instruction received from the GPU 101, further, the frame buffer 114 or the like capable of storing the generated image data at high speed and outputting the data to the monitor 150 at high speed.

Incidentally, when a number of polygons constituting the object of the processing becomes successively large, it is difficult to execute the game screen displaying processing shown in FIG. 10 at a frequency of about 30 times per second. Hence, the various objects including the flying boat ob1 are constituted by more or less large polygons such that a number of the polygons is not excessively large. As described above, the polygon is constituted by a plane polygonal shape and therefore, when the polygon becomes successively large, there is brought about a drawback that a surface of the object becomes angular. However, fortunately, on the screen of the game, the object is frequently moved, in addition thereto, the monitor 150 is not provided with a high drawability as in a photograph and therefore, it is not conspicuous that a surface of the object is angular and therefore, there is not brought about a drawback that a feeling of presence of the game is deteriorated.

However, when the screen of the monitor 150 is printed by a printing apparatus, such a situation is changed at all. That is, in addition to the fact that the image provided by printing is a stationary image, a printing apparatus in recent years is provided with a high drawability near to that of a photograph and therefore, there is a case in which it is found that a surface of the object is angular by seeing the printed image. Further, after seeing the printed image, even in the object displayed on the monitor 150 in the midst of the game, the surface looks to be angular and there is a concern that the feeling of presence of the game is significantly deteriorated. In contrast thereto, according to the game machine 100 of this embodiment, even when the screen of the monitor 150 is printed by a printing apparatus, a clear image as if a real object were taken by a photograph can be outputted.

Further, normally, such a clear image is not displayed on the monitor 150 and therefore, when the clear image as if a real object were taken by a photograph can be printed, a dissociation from the image confirmed by the monitor 150 is enhanced and it is difficult to predict an image provided by printing. In view of the point, according to the game machine 100 of the embodiment, the following processing is executed to be able to further accurately grasp the printed image from the monitor 150.

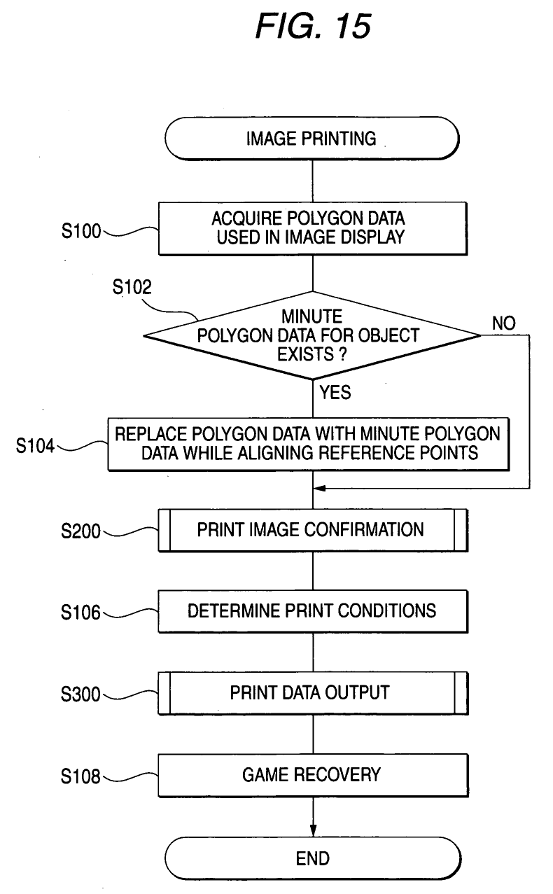

The image printing processing will be described with reference to the flowchart shown in FIG. 15.

When the CPU 100 of the game machine 100 detects that a predetermined printing button provided at the controller 102 is depressed, the CPU 101 starts the image printing processing shown in FIG. 15 by generating an interruption. Further, when the interruption is generated, a processing which has been carried out by the CPU 101 is temporarily interrupted, in accordance therewith, the game is interrupted from being advanced until finishing the image printing processing.

When the image printing processing is started, first, the CPU 101 acquires polygon data constituting the basis of an image displayed on the monitor 150 at a time point of depressing the printing button of the controller 102 (step S100). That is, as described above, an image displayed on the monitor 150 is the image provided by projecting the object to the projected face R and coordinate values of apexes of polygons constituting the object are stored to the main memory 110 as polygon data. Hence, at step S100, polygon data of objects are acquired with regard to respective objects displayed on the monitor 150 at the time point of depressing the printing button of the controller 102.

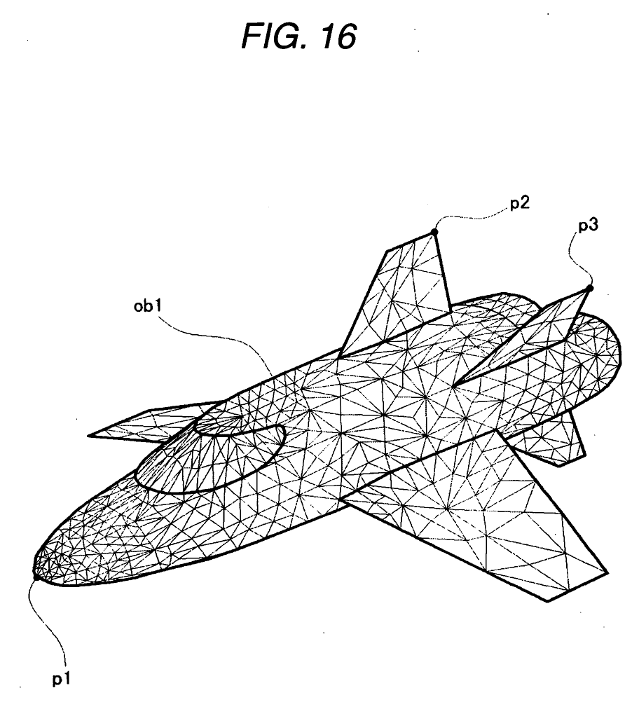

Successively, it is determined whether minute polygon data is stored with regard to the acquired polygon data (step S102). Here, the minute polygon data is data expressing the three-dimensional shape of the object by polygons smaller than the polygons used in the above-described game screen displaying processing. As shown in FIG. 16, the minute polygon data is data of expressing the surface shape of the object by three-dimensional coordinate values of respective apexes constituting such polygons.

Further, also the minute polygon data is provided with a plurality (three in the embodiment) of reference points similar to the normal polygon data shown in FIGS. 7 and 9. The reference points are provided at the same positions in a case where the minute polygon data and in a case where the normal polygon data in view of positional relationships thereof relative to the object. For example, as shown by FIG. 7, in the normal polygon data of the flying boat ob1, the reference points p1, p2, p3 are provided at the front end of the airframe and the rear ends of the left and right stabilizers. Similarly, even in the minute polygon data of the flying boat ob1, the reference points p1, p2, p3 are respectively provided at the front end of the airframe and the rear ends of the left and right stabilizers. In this way, with regard to the object at which the minute polygon data is existed, the reference points are provided at the same positions relative to the object with regard to each of the normal polygon data and the minute polygon data. Conversely speaking, with regard to the object in which the minute polygon data is not existed, it is not necessarily needed that the reference points are set to the object data.

When FIGS. 7 and 16 are compared, in comparison with the polygon data used in the game screen displaying, it is apparent that smaller polygons are used in the minute polygon data. Further, it is apparent that the larger the curvature (the smaller the radius of curvature) of a portion on the surface of the object, by the smaller polygon, the portion is constituted. When the small polygons are used in this way, a shape of the object can further accurately be expressed and even the portion having the large radius of curvature of the surface does not give an angular impression to a viewing person.

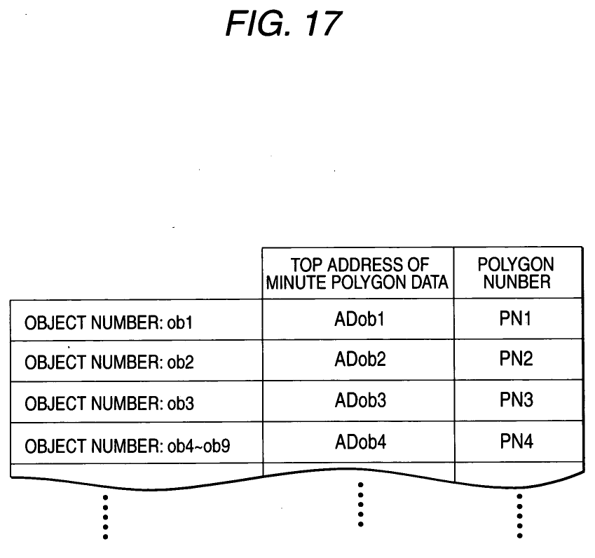

It can be determined whether the minute polygon data is existed by referring to a table (minute polygon data table) previously set with presence or absence of the minute polygon data. As shown in FIG. 17, the minute polygon data table is set with an object number of the object in which the minute polygon data is existed and a polygon number. Therefore, when the object number is set by referring to the minute polygon data table, it can be determined that the minute polygon data is existed with regard to the object. Conversely, when the object number is not set to the minute polygon data table, it can be determined that the minute polygon data is not existed with regard to the object.

Further, the object table described above in reference to FIG. 8 is set with the inherent object numbers and the top addresses of the polygon data with regard to all the objects. On the other hand, according to the minute polygon data table, there is a case in which the same top address is set to a plurality of the object numbers. For example, as shown by FIG. 4, all of the objects of objects ob4 through ob9 express the flying circular disks and the flying circular disks are constituted by the same shape. In such a case, in the minute polygon data table, as shown by FIG. 7, with regard to the six objects having the object numbers ob4 through ob9, the same top address and the same polygon number are set. A description will be given later of a reason that in the minute polygon data table, there is a case in which the same top address and the polygon number are set to different object numbers.

At step S102, with regard to the object in which it is determined that the minute polygon data is existed, a processing of switching the polygon data which is previously acquired at step S100 by the minute polygon data in a state of making the reference points coincide with each other is executed (step S104). A detailed explanation will be given of a content of the processing as follows. First, based on the top address set to the minute polygon data table, the minute polygon data are read to store to consecutive addresses of the main memory 110. Here, the minute polygon data are stored to a continuous region at an after address value Appd on the main memory 110.

Successively, by executing coordinates transformation of moving or rotating the object with regard to the minute polygon data stored to the memory region at and after the address Appd of the main memory 110, the coordinates of the reference point of the minute polygon data are made to coincide with coordinates of the reference points of the normal polygon data acquired at step S100. Such a coordinates transformation is executed not for data indicated by the top address of the minute polygon table shown in FIG. 17 but for data constituted by reading the minute polygon data to be expanded at and after address Appd of the main memory 110. Further, when the coordinates of the reference point of the minute polygon data are made to coincide with the coordinates of the reference point of the normal polygon data, the top address and polygon number of the object table described above in reference to FIG. 8 are rewritten by the top address Appd of the memory region stored with the normal polygon data and the polygon number constituting the minute polygon data. When the top address and the polygon number set to the object table are rewritten in this way, in the rendering processing and the drawing processing executed successively, not the normal polygon data but the minute polygon data are referred. At step S104 of FIG. 15, the processing of switching the polygon data by the minute polygon data is specifically a processing of rewriting the top address and the polygon number set to the object table in this way by the top address and the polygon number positioned minute polygon data.

Here, an explanation will be given of the reason that in the minute polygon data table, the same top address and the same polygon number are set to the different object numbers. As described above, with regard to the object in which the minute polygon data is existed, after reading the minute polygon data, the minute polygon data is moved or rotated such that the coordinates of the reference point coincide with the coordinates of the reference point of the normal polygon data. Here, the different objects are necessarily provided with the different three-dimensional coordinate values and therefore, even when the same minute polygon data is read, after movement or rotation, the same minute polygon data becomes minute polygon data different from each other. Therefore, when such an operation is executed in the different regions of the main memory 110 of the respective objects, the same data can be used for the inherent minute polygon data and therefore, in the minute polygon data table, the objects having the same shape are set with the same top address and the same polygon number.

In the processing at step S104, with regard to the object in which the minute polygon data is existed, the processing of switching the polygon data by the minute polygon data in this way is executed. On the other hand, with regard to the object in which the minute polygon data is not existed, such a processing may be skipped.

When the minute polygon data is switched in this way, at this occasion, a processing of confirming a printed image is started (step S200). That is, whereas as described above, the color printer 200 is provided with the high drawability near to a silver salt photograph, the drawability of the monitor 150 is not high to such a degree and therefore, when the image displayed on the monitor 150 is actually printed, there is a case in which the image having an impression which is significantly different from an anticipated impression is provided. Hence, in order to alleviate such a discrepancy, an image as near to a printed image as possible is displayed on the monitor 150 to confirm an image provided by being actually printed.

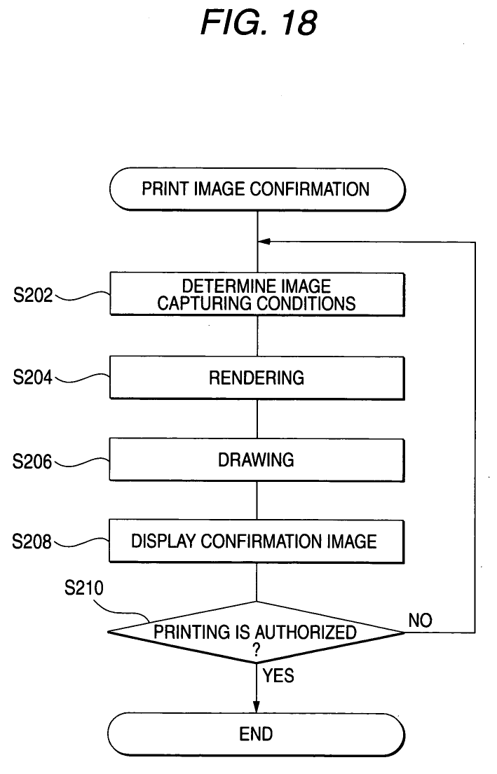

As shown in FIG. 18, when the printed image confirming processing is started, first, the CPU 101 of the game machine 100 starts a processing of setting a condition of capturing the image (step S202). The image capturing condition is set while an operator of the game machine 100 is confirming a screen displayed on the monitor 150.

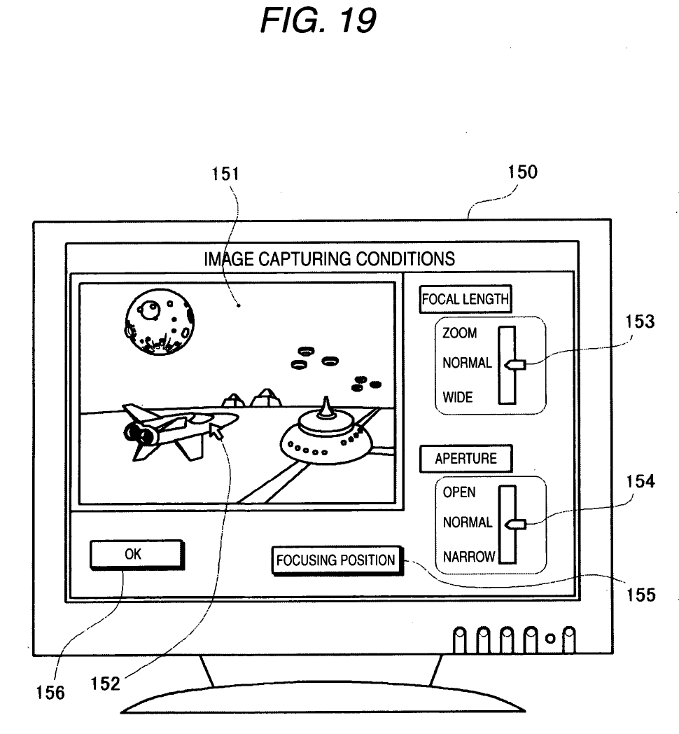

As shown in FIG. 19, substantially a center of the screen for setting the image capturing condition is provided with a monitor region 151 for displaying the screen displayed on the monitor 150 when a printing button is depressed. Further, a periphery of the monitor region 151 is provided with buttons for setting a focal length, an aperture value, a focusing position and the like. In this embodiment, a screen displayed on the monitor 150 is not simply printed but by setting the items, thereby, the image on the monitor 150 can be printed as if a photograph were taken by operating a virtual camera.

A focal length is set by selecting focal lengths from zoom to wide angle by moving a knob 153 provided on a right side of the monitor region 151 in an up and down direction. Further, the aperture value is set by selecting a value from an open side to a narrow side by moving a knob 154 provided on the right lower side of the monitor region 151 in the up and down direction. Further, the focusing position can be set by moving a cursor 152 displayed on the monitor region 151 while operating a cross cursor of the controller 102 to a position intended to focus and thereafter depressing a button displayed as “focusing position” on the set screen. An effect of the image capturing condition set in this way is reflected to the image displayed on the monitor region 151 and therefore, the image capturing condition can be set while confirming the effect. Further, when a desired image capturing condition is determined, by depressing a button 156 displayed as “confirmation” on the set screen, the set image capturing condition is firmly determined and a processing of confirming the printed image reflected with the image capturing condition is started. At step S202 of the printed image confirming processing shown in FIG. 18, the processing of setting various image capturing conditions is executed as described above.

Prior to the processing for confirming the printed image, first, a tendering processing and a drawing processing are executed (step S204 and step S206). As described above, the rendering processing is the processing of forming the data of the two-dimensional image from the polygon data of the respective objects. Such a processing can be executed by calculating projected images of respective objects to the projecting face R set between the observing point Q and the respective objects as described above in reference to FIG. 11. Further, the drawing processing is a processing of forming the image data set with the gray scale values for the respective pixels from the projected image formed by the rendering processing. Similar to the game screen displaying processing described above in reference to FIG. 10, the rendering processing is executed while referring to the object table by the GTE 112 under control of the CPU 101 and the data of the provided two-dimensional image is stored to the main memory 110. A content set by the image capturing condition setting processing is reflected to setting the observing point Q and the projecting face R in the rendering processing. Further, with regard to the object disposed to be remote from or proximate to the observing point Q, a special operation of providing a filter for blurring the projected image is also executed in accordance with setting the aperture value.

The GPU 116 executes the drawing processing executed successively by receiving a drawing instruction outputted by the CPU 101 and the acquired image data is stored to the frame buffer 114. An explanation will be omitted here of detailed contents of the rendering processing and the drawing processing. However, with regard to the object in which the minute polygon data are present since the object table (refer to FIG. 8) is rewritten at the above-described step S204, the rendering processing and the drawing processing are not executed with respect to the normal polygon data displayed on the monitor 150 when the printing button is depressed, but executed with respect to the minute polygon data.

Successively, in order to confirm a printed image, a processing of displaying the image on the monitor 150 is executed (step S208). That is, by executing the rendering processing (step S204) and the drawing processing (step S206), the image data of the two-dimensional image is formed to the frame buffer 114 of the game machine 100 and therefore, by reading the image data to supply to the monitor 150 as a video signal, the printed image is displayed. As described above, the rendering processing and the drawing processing are executed for the minute polygon data, as a result, the image data stored to the frame buffer 114 is the image data formed based on the minute polygon data. Therefore, an image having a high image quality formed by using the small polygons is displayed.

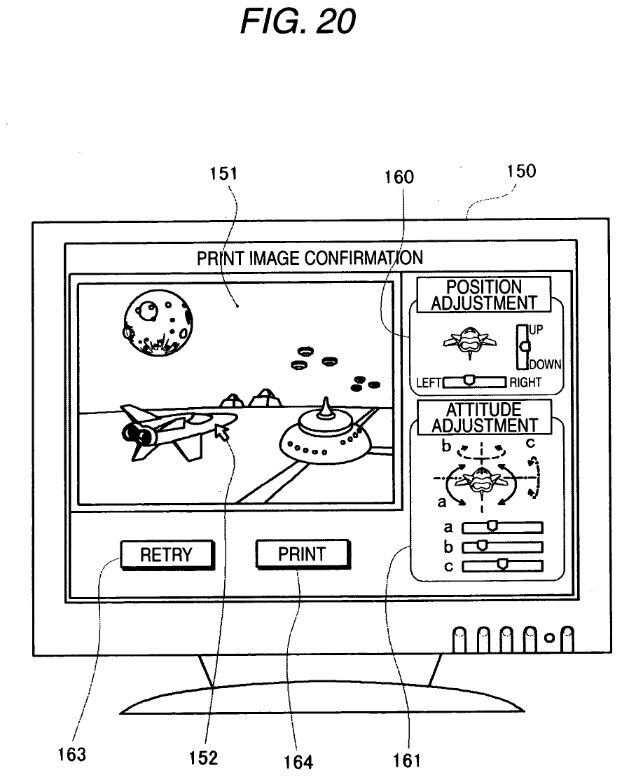

As shown in FIG. 20, the printed image is displayed in the monitor region 151 provided substantially at the center of the monitor screen. Further, a right side of the monitor region 151 is provided with regions 160, 161 for setting a position of displaying the flying boat ob1 and correcting an attitude thereof. The region 160 is a region for correcting the position of displaying the flying boat ob1 and is provided with a knob for correcting the position of the flying boat ob1 in the printed image in an up and down direction and a knob for correcting the position in a left and right direction. By moving the knobs to desired positions by using the cursor 152, a content of correcting the position of displaying the flying boat ob1 can be set. Further, the region 161 is a region for correcting the attitude of the flying boat ob1. The region 161 is provided with: a knob “a” for rotating the flying boat ob1 in a direction indicated by arrows “a” about a rotation axis extending in a front-rear direction of the flying boat; a knob “b” for rotating the nose of the flying boat ob1 in a direction indicated by arrows “b” about a rotation axis extending in an upper-lower direction of the flying boat; and a knob “c” for rotating the flying boat ob1 in a direction indicated by arrows “c” about a rotation axis extending in a left-right direction of the flying boat. By moving the knobs by using the cursor 152; the content of correction with regard to an inclination (that is, attitude) of the airframe of the flying boat ob1 can be set in the printed image.

At step S208 of the printed image confirming processing of FIG. 18, as described above, the image data formed based on the minute polygon data is displayed on the monitor 151 and when needed, the processing of correcting the position of displaying or the attitude of the object which is executed.

Next, it is confirmed whether the printed image displayed on the monitor 151 may be printed (step S210). As shown by FIG. 20, the printed image confirming screen is provided with a button 163 displayed as “retry” and a button 164 displayed as “print” on the lower side of the monitor region 151, when the operator of the game machine 100 selects the button 163 displayed as “retry”, the CPU 101 determines that the printing is not permitted (step S210: No). Further, in this case, the operation returns to step S202 and executes the image capturing condition setting processing (step S202), the rendering processing (step S204), and the drawing processing (step S206). At this occasion, when the position of displaying and the attitude of the object displayed on the monitor region 151 are corrected, after converting coordinate values of the polygon data by reflecting the content of correction, the rendering processing and the drawing processing are executed, and the provided image data is read from the frame buffer 114 and outputted to the monitor 150 as the video signal (step S208). Thereby, the confirmed image reflected with correction of the display position or the attitude of the object is displayed. Naturally, even when the display position or the attitude of the object does not need to be corrected, by selecting the button 163 displayed as “retry” in the printed image confirming screen shown in FIG. 20, the image capturing condition can also be corrected.

In this way, according to the image printing processing of the embodiment, by executing the printed image confirming processing prior to printing the screen displayed on the monitor 150, the image formed based on the minute polygon data can be confirmed on the monitor 150 and can be corrected when needed.

On the other hand, when the operator of the game machine 100 selects the button displayed as “print” on the printed image confirming screen shown in FIG. 20, the CPU 101 determines that printing is permitted (step S210: Yes), finishes the printed image confirming processing shown in FIG. 18 and returns to the image printing processing of FIG. 15. Further, even in a case in which the operator of the game machine 100 does not select the button 164 displayed as “print”, when the operation of correcting the display position or the attitude of the object, or the operation of selecting the button 163 displayed as “retry” is not executed for a predetermined time period or more, the printed image confirming processing shown in FIG. 18 may be finished by determining that printing is permitted (step S210: Yes). Thereby, even when the operator does not execute any operation, the operator can return to the interrupted game.

When the processing for confirming the printed image on the monitor 150 has been finished as described above, the CPU 101 of the game machine 100 starts a printing condition setting processing (step S106). The operator of the game machine 100 also executes the printing condition setting processing while confirming the screen displayed on the monitor 150 similar to the case of setting the image capturing condition.

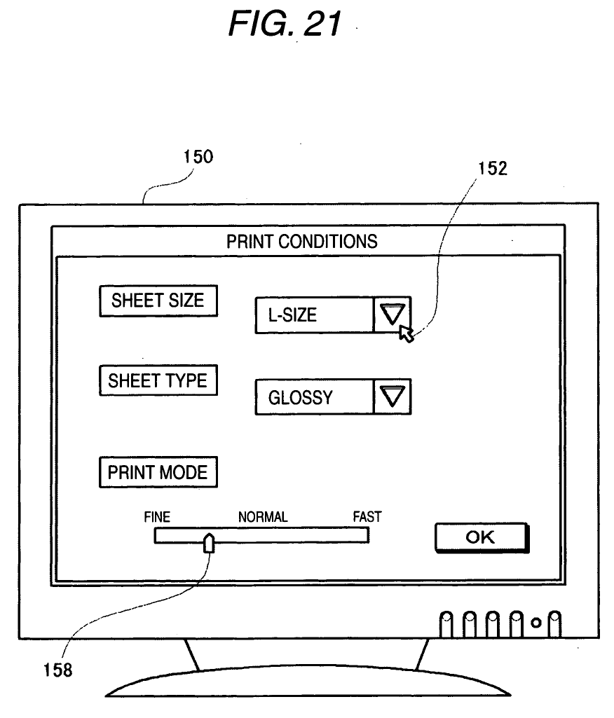

As shown in FIG. 21, in this embodiment, three items of a sheet size, a sheet kind used in printing and a printing mode in printing can be set. The sheet size and the sheet kind are set by selecting the sheet size by using the cursor 152 displayed on the screen by operating the dross cursor of the controller 102. Further, the printing mode can be set by moving a knob 158 displayed on the screen from “fine” to “fast”. Further, in addition to the conditions, items of a number of sheets of printing and whether so-to-speak marginless printing is executed may be able to be set. When the printing condition is set as, described above, by depressing a button displayed as “OK” on the set screen, the set printing condition is firmly determined.

When the printing condition is set, the CPU 101 of the game machine 100 starts a processing of forming the print data from the image data stored to the frame buffer 114 to output to the color printer 200 (printed data outputting processing) (step S300).

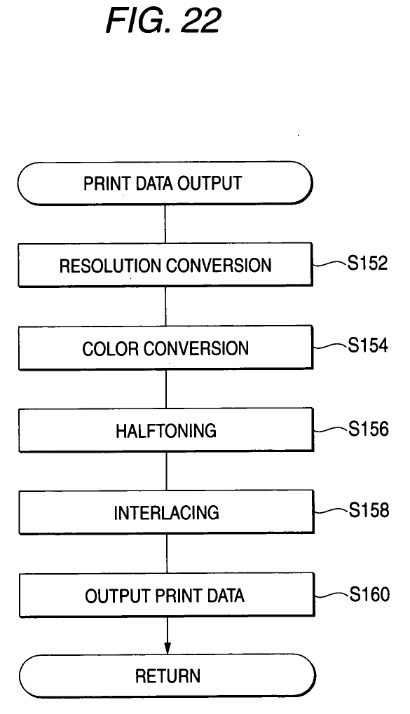

As shown in FIG. 22, when the printed data outputting processing is started, first, the CPU 101 starts a resolution converting processing (step S302). The resolution converting processing is a processing of converting a resolution of the image data stored to the frame buffer 114 to a resolution by which the image of the color printer 202 is intended to print (print resolution). Further, the print resolution is determined by a number of pixels constituting the screen of the monitor 150 and a size of the image to be printed, that is, a size of print sheet set by the above-described printing condition setting processing (step S106 of FIG. 15).

Further, when the print resolution is higher than the resolution of the image data, the resolution is increased by forming new image data between the pixels by executing an interpolating operation. Conversely, when the resolution of the image data is higher than the print resolution, the resolution is reduced by omitting the read image data by a constant rate. In the resolution converting processing, by executing the operation to the image data of the frame buffer 114, the resolution of the image data formed by the drawing processing is converted to the print resolution.

When the resolution of the image data is converted into print resolution in this way, at this occasion, a color converting processing is executed (step S304). The color converting processing is a processing of converting RGB color image data expressed by a combination of gray scale values of R, G, B to image data expressed by a combination of gray scale value of respective colors used for printing. As described above, according to the game machine 100 of the embodiment, whereas the image set with the gray scale values of respective colors of R, G, B are formed for the respective pixels, in the color printer 200, as shown by FIG. 2, the image is printed by using four colors (C, M, Y, K) of ink. Hence, there is executed a processing (color converting processing) of converting the image data expressed by respective colors of R, G, B to data expressed by the gray scale values of respective colors of C, M, Y, K.

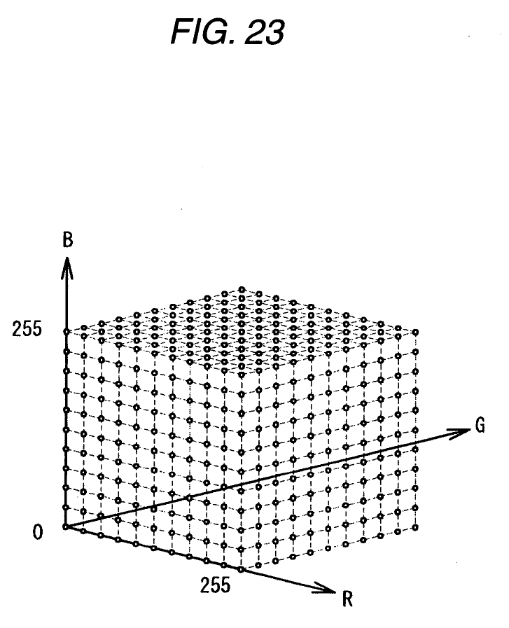

The color converting processing can swiftly be carried out by referring to a color converting table (LUT). The LUT can be regarded as a kind of a three-dimensional mathematical table when considered in the following way. First, consider a color space assigning R axis, G axis, B axis to three axes orthogonal to each other as shown by FIG. 23. Then, all of RGB image data can be displayed necessarily in correspondence with coordinate points in the color space. Therefrom, when R axis, G axis, B axis are finely divided and a number of lattice points are set in the color space, the respective lattice points can be considered to express the image data and gray scale values of respective colors of C, M, Y, K in correspondence with the image data of RGB can be made to correspond to the respective lattice points. The LUT is a kind of a three-dimensional mathematical table in which the gray scale values of respective colors of C, M, Y, K are made to correspond to the lattice points provided in the color space to store. When the color converting processing is executed based on a corresponding relationship between the image data of RGB and the gray scale data of respective colors of C, M, Y, K stored in LUT, the image data expressed by the gray scale values of respective colors of RGB can swiftly be converted into the gray scale data of respective colors of C, M, Y, K.

Further, when a print sheet differs, a ground color of sheet differs and also color development of ink differs. Further, a way of oozing ink differs by a kind of print sheet and a difference in a way of oozing ink effects an influence on a tone of color. Therefrom, in order to print an image having a high image quality, it is preferable to properly use a pertinent LUT in accordance with a kind of print sheet. Hence, at step S304, the color converting processing is executed by properly using the previously determined LUT in accordance with the kind of the print sheet set by the above-described printing condition setting processing (step S106 of FIG. 15).

When the above-described color converting processing is executed, the CPU 101 of the game machine 100 starts a halftoning processing (step S306). The halftoning processing is the following processing. Image data provided by the color converting processing is gray scale data which can take values from a gray scale value 0 to a gray scale value 255 for respective pixels when a data length is set to 1 byte. In contrast thereto, the color printer 200 expresses an image by forming dots and therefore, only either of states of “forming dot” and “not forming dot” can be selected for respective pixels. Therefore, the color printer 200 expresses a middle gray scale by changing a density of dots formed in a predetermined region instead of changing the gray scale values of the respective pixels. The halftoning processing is a processing of determining whether dots are formed or not for respective pixels such that dots are produced by a pertinent density in accordance with the gray scale value of the image data.

As a method of producing dots by a pertinent density in accordance with the gray scale value, various methods of an error diffusing method, a dithering method and the like are applicable. The error diffusing method is a method of determining whether dots are formed or not with regard to respective pixels such that an error in expressing the gray scale produced at a pixel by determining whether dots are formed or not with respect to a certain pixel is diffused to surrounding pixels and an error diffused from surrounding is resolved. A rate of diffusing the produced error to surrounding respective pixels is set previously to an error diffusing matrix. Further, the dithering method is a method of determining whether dots are formed or not with regard to respective pixels by comparing a threshold set in a dithering matrix and a gray scale value of image data for respective pixels, determining to form dots for a pixel at which the gray scale of the image data is larger and conversely determining not to form dots with regard to a pixel in which the threshold is larger. In this embodiment, either of the methods can be used, however, at this occasion, the halftoning processing is executed by using the method referred to as the dithering method.

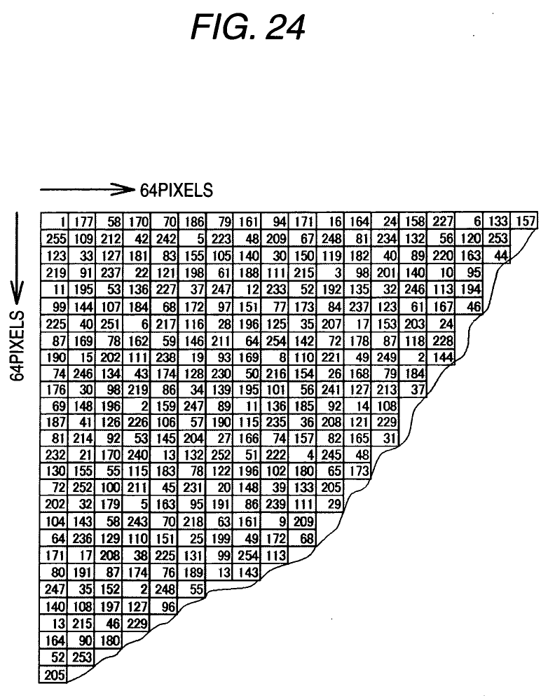

As shown in FIG. 24, the matrix is set with thresholds evenly selected from a range of gray scale values of 0 through 255 for respective vertical and horizontal 64 pixels, or a total of 4096 pieces of pixels. Here, the gray scale values of the thresholds are selected from the range of 0 through 255 in correspondence with the fact that the image data is constituted by 1 byte data and the gray scale values set for the pixels can take values of 0 through 255. Further, a size of the dithering matrix is not limited to an amount of vertical and horizontal 24 pixels as exemplified in FIG. 24 but can be set to various sizes including a size in which numbers of vertical and horizontal pixels differ from each other.

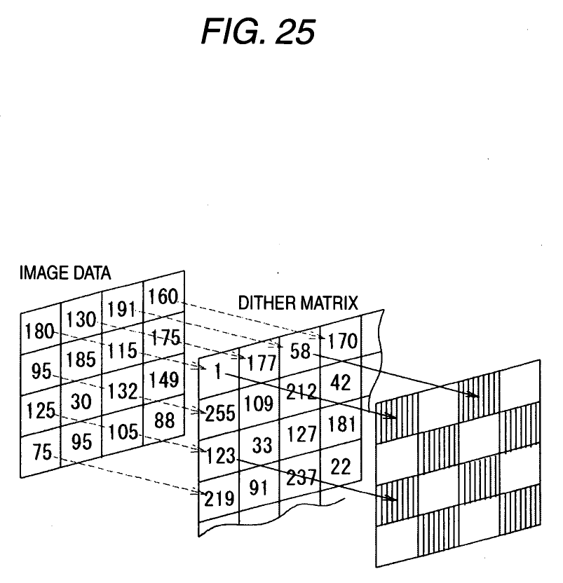

In determining whether dots are formed or not, first, a gray scale value of image data with regard to a pixel aimed as an object of determination (aimed pixel) and a threshold stored to a corresponding position in the dithering matrix are compared. Dashed arrows shown in FIG. 25 schematically expresses that the gray scale value of the aimed pixel and the threshold stored at the corresponding position in the dithering matrix are compared. Further, when the gray scale of the aimed pixel is larger than the threshold of the dithering matrix, it is determined that dots are formed for the pixel. Conversely, when the threshold of the dithering matrix is larger, it is determined that dots are not formed for the pixel.

In this example, the image data of a pixel disposed at a left upper corner of image data is provided with a gray scale value of 180 and a threshold stored at a position on the dithering matrix in correspondence with the pixel is 1. Therefore, with regard to the pixel at the left upper corner, the gray scale value 180 of the image data is larger than the threshold 1 of the dithering matrix and therefore, it is determined that dots are formed for the pixel. Solid arrows shown in FIG. 25 schematically expresses a behavior of determining that dots are formed for the pixel and writing a result of the determination to a memory. On the other hand, with regard to a right next pixel of the pixel, the gray scale value of the image data is 130, the threshold of the dithering matrix is 177, the threshold is larger and therefore, it is determined that dots are not formed for the pixel. According to the dithering method, dots are produced in reference to the dithering matrix in this way.

At step S306 (halftoning processing) of the printed data outputting processing shown in FIG. 22, the processing of determining whether dots are formed as described above for respective gray scale values of respective colors C, M, Y, K converted by the color converting processing is executed.

When the halftoning processing is finished as described above, the CPU 101 of the game machine 100 starts an interlacing processing (step S308). The interlacing processing is a processing of realigning image data converted into an expressing style by whether dots are formed or not in an order of transferring to the color printer 200 in consideration of an order by which dots are actually formed on a print sheet. The CPU 101 of the game machine 100 realigns the image data by executing the interlacing processing and outputting finally provided data from the GPU 116 to the color printer 200 as print data (step S310). Further, when all the print data are outputted to the color printer 200, the operation finishes the print data outputting processing shown in FIG. 22 to return to the image printing processing of FIG. 15.

In the image printing processing, when the operation returns from the print data outputting processing, a game recovering processing is executed (step S108). The game recovering processing is a processing of restarting, the game by finishing the image printing processing shown in FIG. 15. That is, the above-described image printing processing is started in the state of temporarily interrupting the game by generating an interruption by the CPU 101 of the game machine 100 when the printing button of the controller 102 is depressed as mentioned above. Hence, prior to the image printing processing, the CPU 101 prepares to restart the game by recovering a program counter and various data to a state before interrupting the game. As mentioned above, with regard to the object in which the minute polygon data is existed, also the set value of the object table is rewritten in the image printing processing and therefore, also the set value is recovered to an original set value in the game recovering processing.

When the game recovering processing is finished in this way (step S108), also the image printing processing shown in FIG. 15 is finished. Various variables and data including the program counter are recovered to a state before interrupting the game and therefore, the game can be restarted when the game is interrupted.

On the other hand, the color printer 200 prints an image by forming dots on print sheet in accordance with print data supplied from the GPU 116 in this way. That is, as described above in reference to FIG. 2, primary scanning and secondary scanning of the carriage 240 are executed by driving the carriage motor 230 and the sheet feeding motor 235 and ejecting ink drops by driving the printing head 241 in accordance with movements thereof, thereby, ink dots are formed. As a result, a printed image of a scene the same as that displayed on the screen of the monitor 150 is provided.

As described above, in the image printing processing, print data is formed from the minute polygon data and therefore, in the print data, a surface of the object is expressed as a smooth surface including a curved face portion. Therefore, in the printed image provided based on the print data, the surface of the object is not angular and the printed image can be provided as if an existing object were taken by a photograph.

Of course, when the object is constituted by using small polygons as in the minute polygon data from the start, even in a case of printing the screen displayed on the monitor 150 as it is, the image can be provided as if the image were taken by a photograph. However, thereby, a number of polygons constituting the object is increased and therefore, the image in the midst of the game cannot swiftly be displayed. In this embodiment, therefore, the image in the midst of the game is displayed on the monitor 150 by using the polygon data formed by large polygons, and new minute polygon data is formed based on the content of the polygon data used for proceeding the game when the screen is printed. Accordingly, while swiftly displaying the game in the midst of the game, the image having the high image quality as in a photograph can be printed.

Further, when the image is printed, a number of the polygons need to be processed and therefore, it is difficult to swiftly process the number of polygons as in a case of displaying on the monitor 150. However, in this embodiment, since the image printing processing is executed while the game is interrupted, print data can be formed by taking a sufficient time period even when the number of the minute polygon data is increased, a practical drawback is not brought about. When the minute polygon data is made to substitute for the normal polygon data for forming the print data, the substitution is executed after positioning the minute polygon data such that coordinate values at which the reference point of the normal polygon data is present at a time point of interrupting the game and coordinate values of a reference point of the minute polygon data overlap each other. Therefore, although in the polygon data actually different from the image displayed on the monitor 150 when the printing button of the controller 102 is depressed is used, the image having the high image quality can be outputted as if the image displayed on the monitor 150 were printed as it is.

When the image having the high image quality can be printed in this way, a discrepancy from the image quality of the image displayed on the monitor 150 in the midst of the game is increased and therefore, there is a case in which it is difficult to grasp the state of the printed image from the screen displayed on the monitor 150. That is, when the image is actually printed and a clear image is taken by the hand, there is a case of receiving an impression which differs from that of the image viewed on the monitor 150. However, in this embodiment, before actually printing the screen displayed on the monitor 150, the printed image can be confirmed on the monitor 150. Although the monitor 150 is not provided with a drawability as high as that of the color printer 200, the image quality equivalent to that of the image provided actually by printing cannot be displayed on the monitor 150. However, by displaying the image the same as the image data having the high image quality produced for printing on the monitor 150, the behavior of the image provided in printing actually can further precisely be grasped.

Further, in the image printing processing explained above, an explanation has been given such that the screen displayed on the monitor 150 in the midst of the game is printed. In this case, an arbitrary screen in the midst of the game can be printed. However, the image may be able to be printed not in the arbitrary screen but only in prescribed stages in the midst of the game, or an extra stage prepared only for image capturing. When the arbitrary screen in the midst of the game is made to be able to be printed, there is a possibility of printing various objects and therefore, the minute polygon data need to be prepared for the objects. In contrast thereto, when the image is made to be able to be printed only in the stage previously set in the midst of the game or only the exclusive stage for image capturing, the minute polygon data to be prepared can be reduced.

In the first embodiment, the minute polygon data is previously stored, in printing the image, the minute polygon data substitutes for the normal polygon data, thereafter, the image is printed by executing a series of processings of the rendering processing, the drawing processing and the like for respective objects including the minute polygon data. Incidentally, the minute polygon data may be formed from the normal polygon data without previously preparing the minute polygon data and the series of processings including the rendering processing and the processing of confirming the printed image may be executed for the data. Next, such an image printing processing will be described as a second embodiment of the invention.

The processing of this embodiment significantly differs from the image printing processing of the first embodiment in that the minute polygon data is formed from the normal polygon data and the processing of other portion is substantially similar to the processing of the first embodiment.

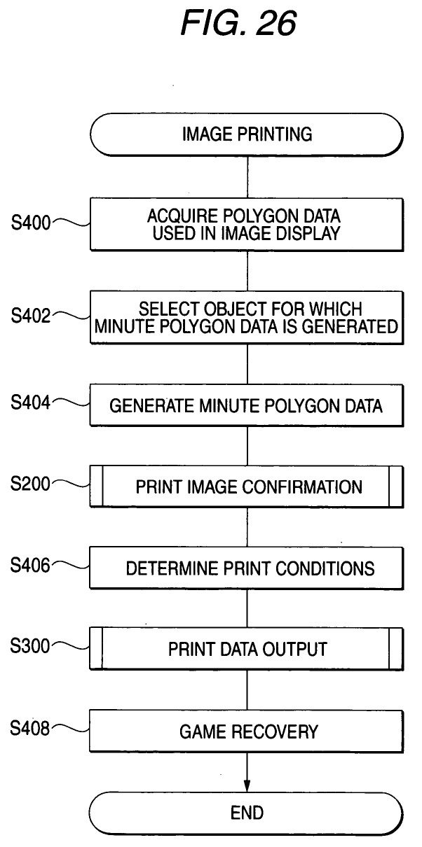

Also in the image printing processing of the second embodiment, similar to the above-described first embodiment, the CPU 101 of the game machine 100 starts the image printing processing by generating an interruption when it is detected that the predetermined printing button provided at the controller 102 is depressed as shown in FIG. 26. Further, first, polygon data constituting the basis of the image displayed on the monitor 150 is acquired at the time point of depressing the printing button of the controller 102 (step S400).

Successively, an object of forming minute polygon data is selected from objects acquiring polygon data (step S402). The object is selected as follows.

As describe above, the size of the polygon constituting the object is determined by the balance between a request for accurately expressing a surface of the object and a request for swiftly executing the game screen displaying processing shown in FIG. 10. Therefore, basically, the polygon is constituted substantially by the same size without depending on the object. However, as shown by FIG. 11, in the rendering processing, the two-dimensional image is formed by calculating the projected image of the polygon constituting the object and the more remote is the object from the projected face R, the smaller the size of the polygon constituting the projected image. Therefore, even when the size of the polygon constituting the object stays the same, the size of the polygon constituting the projected image becomes small for the object disposed to be remote and becomes large for the object disposed to be proximate.

Hence, in this embodiment, with regard to an object in which a size of the polygon constituting the projected image is equal to or larger than a predetermined value, the minute polygon data is formed and the successive series of processings are executed while the polygon data stays to be a normal polygon data with regard to the other object. Step S402 of FIG. 26 executes a processing of selecting an object in which the polygon constituting the projected image is provided with a size equal to or larger than a predetermined value as an object of forming the minute polygon data.

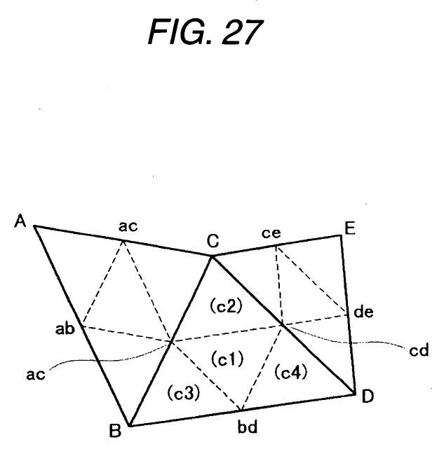

Next, with regard to a selected object, a processing of forming the minute polygon data from the normal polygon data acquired at step S400 is started (step S404). Triangular shapes indicated by solid lines in FIG. 27 are respectively polygons having normal sizes. In forming the minute polygon data, a small polygon is formed by dividing the polygon by connecting middle points of respective sides constituting the polygon. Explaining with regard to a triangular shape ABC shown in FIG. 27, by respectively connecting a middle point ab of a side AB, a middle point bc of a side BC and a middle point ac of a side AG (as indicated by dashed lines), the triangular shape ABC can be divided into four small triangular shapes. Also with regard to a polygon BCD adjacent thereto, similarly, when the middle point bc of the side BC, a middle point cd of a side CD and a middle point bd of a side BD are respectively connected, a triangular shape BCD can be divided into four triangular shapes. When such an operation is repeated, all of polygons constituting the object can be divided into small polygons.

Naturally, the triangular shape can be divided into four small triangular shapes also by connecting not the middle point of the respective sides but points arbitrarily disposed on the sides. However, when the triangular shape is divided by connecting the middle points of the respective sides, the triangular shapes formed by being divided can be constituted substantially by the same size. That is, the polygon can pertinently be divided by comparatively simple operation.

Further, a texture number of the small polygon formed in this way is determined based on a texture number of the original polygon and a texture number of the adjacent polygon. As an example, an explanation will be given by using the polygon of the triangular shape BCD shown in FIG. 27. With regard to a small polygon c1 formed at a center, a texture number of the original polygon is assigned as it is. On the other hand, with regard to a small polygon c2 interposed by two adjacent polygons (triangular shape ABC, triangular shape CDE), a texture number which is the middle of the texture numbers of the two adjacent polygons and a texture of a polygon constituting the basis (triangular shape BCD) is set. Similarly, with regard to a small polygon c3 formed by being divided, a texture number which is the middle of the texture number of the adjacent polygon (triangular shape ABC) and the texture number of the original polygon (triangular shape BCD) may be set. As described above, when the polygons are divided into small polygons, apexes of the polygons formed by being divided are detected and texture numbers of the respective polygons are set, the minute polygon data can be formed from the normal polygon data.

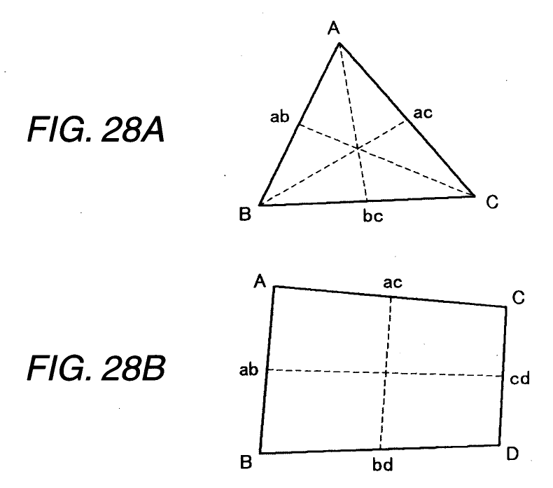

Further, although in the above-described explanation, the polygon is divided by connecting middle points, the polygon may be divided by connecting apexes and middle points of sides opposed thereto (opposite sides) as shown in FIG. 28A. When a polygon is divided in this way, a triangular polygon can be divided into six small triangular polygons. Further, when the polygon is divided by connecting an apex and a middle point of an opposite side, sizes of polygons formed by being divided can be made to be substantially the same. Further, when a polygon is constituted by a quadrangular shape, as shown by FIG. 28B, the polygon may be divided by connecting middle points of sides opposed to each other.

At S404 shown in FIG. 26, there is executed a processing of forming minute polygon data by dividing the polygon of the selected object in this way and rewriting top addresses and a number of polygons set to the object table with regard to the objects.

Further, in this embodiment, the polygon data when the printing button of the controller 102 is depressed is acquired (step S400 of FIG. 26) and the minute polygon data is formed from the polygon data. That is, a position and a direction of the object expressed by the formed minute polygon data placed in the three-dimensional space coincide with those of the object expressed by the acquired polygon data. Therefore, it is not necessary to position the normal polygon data and the minute polygon data by using the reference point as in the above-described image printing processing of the first embodiment, further, it is not also necessary to set the reference point as the polygon data. Therefore, even when the game machine 100 having relatively small memory capacitance and processing function is used, the image can swiftly be printed.

When the minute polygon is formed as described above, thereafter, similar to the above-described image printing processing of the first embodiment, the processing of confirming the printed image is executed, thereafter, the image is printed. In the following, a simple explanation will be given by referring to FIG. 18.

First, the image capturing condition of the image is set (step S202). The image capturing condition can be set while confirming the screen displayed on the monitor 150 (refer to FIG. 19). Successively, the rendering processing and the drawing processing are executed (steps S204, S206). In the rendering processing, the CPU 101 supplies the top address and a number of polygon stored with the polygon data or the minute polygon data to the GTE 112 in reference to the object table and by receiving these, the GTE 112 executes the rendering processing and stores a provided result to the main memory 110. Successively, the CPU 101 outputs the drawing instruction to the GPU 116 by referring to the main memory 110. Then, the GPU 116 converts the two-dimensional image formed by the rendering processing into the image data in which the gray scale data are set to the respective pixels to store to the frame buffer 114.

The image data provided in this way is read from the frame buffer 114 to display on the monitor 150 (refer to FIG. 20). The monitor region 151 is displayed with the printed image having the high image quality formed by using the minute polygon data. Further, by moving the knobs provided at the regions 160, 161, the display position or the attitude of the object and displayed printed image can also be corrected. Further, when the display position or the attitude of the object is corrected, or when the image capturing condition is changed, the button 163 displayed as “retry” on the lower side of the monitor region 151 is selected. Then, the above-described series of processings are executed again and the printed image reflected with a connected content is displayed on the monitor region 151. Further, when it is determined that the displayed printed image may be printed, by selecting the button 164 displayed as “print” on the lower side of the monitor region 151 is selected and the printed image confirming processing is finished.

When the printed image confirming processing is finished, successively, the printing condition is set (step S312). The printing condition can be set on the screen displayed on the monitor 150 as described above in reference to FIG. 21. Successively, the above-described printed data outputting processing is started (S300). The content of the processing is quite similar to that of the printed data outputting processing executed in the first embodiment and therefore, an explanation thereof will be omitted here.

When recovered from the print data outputting processing, the game recovering processing is executed (step S314). That is, also the image printing processing of the second embodiment is started by temporarily, interrupting the game and therefore, before finishing the image printing processing, the program counter and the various data are recovered to the state before interrupting the game to prepare for restarting the game. Further, when the game recovering processing is finished, the image printing processing of the second embodiment shown in FIG. 26 is finished.

In this embodiment, upon printing the image displayed on the monitor 150, the minute polygon data is formed by dividing the polygon constituting the object into the small polygons. Naturally, although an accuracy of expressing the object shape is not promoted by only dividing the polygon into the small polygon, when the polygon is divided into the small polygon in this way, by providing pertinent textures to the respective polygons, the impression that the object surface is angular can considerably be alleviated. Therefore, even when the image is outputted from the color printer 200, the printed image can be provided as if an existing object were taken by a photograph.

Incidentally, when the image having such a high image quality can be printed, a discrepancy in the image quality from that of the image displayed on the monitor 150 in the midst of the game is increased and therefore, there is a case in which the printed image becomes an image having an impression which differs from that of the image displayed on the monitor 150. In this embodiment, however, since the image data formed for printing can be confirmed by being displayed on the monitor 150 before actually printing the screen displayed on the monitor 150, the behavior of the image provided in actually printing can precisely be grasped.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. An image data generator, comprising:
a first image data generator, operable to generate first image data representative of a first image of an object, based on first polygon data representative of a three-dimensional shape of the object with coordinates of apexes of each of first polygons constituting a surface of the object and having a first size;
a second image data generator, operable to acquire at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size;
a display, operable to display the first image and the second image; and
a print data generator, operable to cause the display to display the second image when a print instruction for the first image displayed on the display is detected, and operable to generate print data based on the second image data when a print authorization, is acquired, the print data being representative of a third image to be printed by a printer.

2. The image data generator as set forth in claim 1, wherein it is determined that the print authorization is acquired in a case where no instruction is detected while the second image is displayed on the display for a prescribed time period.

3. The image data generator as set forth in claim 1, further comprising a storage, storing the first polygon data and the second polygon data,
wherein the second image data generator is operable to replace the first polygon data with the second polygon data to generate the second image data.

4. The image data generator as set forth in claim 1, wherein the second polygons are formed by dividing at least one of the first polygons.

5. The image data generator as set forth in claim 1, further comprising:
an adjuster, operable to adjust at least one of a position and an attitude of the object in the second image; and
an image updater, operable to change the second polygon data in accordance with the adjustment performed with respect to the at least one of the position and the attitude of the object, in order to update the second image.

6. The image data generator as set forth in claim 1, further comprising an adjuster, operable to adjust a condition for capturing the first image displayed on the first display,
wherein the second image data generator is operable to generate the second image data with reference to the adjusted condition.

7. A printer, comprising:
a first image data generator, operable to generate first image data representative of a first image of an object, based on first polygon data representative of a three-dimensional shape of the object with coordinates of apexes of each of first polygons constituting a surface of the object and having a first size;
a second image data generator, operable to acquire at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size;
a display, operable to display the first image and the second image; and
a print data generator, operable to cause the display to display the second image when a print instruction for the first image displayed on the display is detected, and operable to generate print data based on the second image data when a print authorization is acquired, the print data being representative of a third image to be printed by the printer.

8. An image generating method, comprising:
generating first image data representative of a first image of an object, based on first polygon data representative of a three-dimensional shape of the object with coordinates of apexes of each of first polygons constituting a surface of the object and having a first size;
displaying the first image on a display;
detecting a print instruction for the first image;
acquiring at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size; and
displaying the second image on the display.

9. A printing method, comprising:
generating first image data representative of a first image of an object, based on first polygon data representative of a three-dimensional shape of the object with coordinates of apexes of each of first polygons constituting a surface of the object and having a first size;
displaying the first image on a display;
detecting a print instruction for the first image;
acquiring at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size;
displaying the second image on the display;
generating print data based on the second image data when a print authorization is acquired; and
printing a third image represented by the print data.

10. A program product comprising a program adapted to cause a computer to execute an image generating method, comprising:
generating first image data representative of a first image of an object, based on first polygon data representative of a three-dimensional shape of the object with coordinates of apexes of each of first polygons constituting a surface of the object and having a first size;
displaying the first image on a display;
detecting a print instruction for the first image;
acquiring at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size; and
displaying the second image on the display.

11. A program product comprising a program adapted to cause a computer to execute a printing method, comprising:
generating first image data representative of a first image of an object, based on first polygon data representative of a three-dimensional shape of the object with coordinates of apexes of each of first polygons constituting a surface of the object and having a first size;
displaying the first image on a display;
detecting a print instruction for the first image;
acquiring at least one of the first image data and the first polygon data to generate second image data representative of a second image of the object, based on second polygon data representative of the three-dimensional shape of the object with coordinates of apexes of each of second polygons constituting the surface of the object and having a second size smaller than the first size;
displaying the second image on the display;
generating print data based on the second image data when a print authorization is acquired; and
printing a third image represented by the print data.
